(19) United States
(12) Patent Application Publication
(10) Pub. No.: US 2026/0281001 A1
(43) Pub. Date: Sep. 17, 2026

(54) ARTIFICIAL INTELLIGENCE-DRIVEN NETWORK OPERATION MANAGEMENT

(71) Applicant: Rakuten Symphony, Inc., Tokyo (JP)

(72) Inventors: Dewa Putra Bagus SISWANTO, Tokyo (JP); Tapas RANJAN, Tokyo (JP)

(73) Assignee: Rakuten Symphony, Inc., Tokyo (JP)

(21) Appl. No.: 19/075,987

(22) Filed: Mar. 11, 2025

(51) Int. Cl. H04L 41/16; G06F 16/242; G06F 16/28

(52) U.S. Cl. CPC H04L 41/16; G06F 16/243; G06F 16/2433; G06F 16/285

(57) ABSTRACT

Example embodiments of the present disclosure relate to AI-driven network operation management. According to example embodiments, a device may be configured to: receive a prompt associated with a telecommunication network; determine, via a Natural Language Processing (NLP) operation, an intent of the prompt; generate, via a Retrieval-Augmented Generation (RAG) operation, an enriched prompt that may include information associated with the determined intent; determine a category of the enriched prompt; select, from among a plurality of services, a service associated with the determined category; and provide the selected service based on the enriched prompt.

### TECHNICAL FIELD

The present disclosure relates to artificial intelligence (AI)-driven network operation management.

### BACKGROUND

The information disclosed in this background section is only for the enhancement of understanding of the general background of the disclosure and should not be taken as an acknowledgement or any form of suggestion that this information forms the prior art already known to a person skilled in the art.

A telecommunication network encompasses a wide range of network operations that are critical and essential for maintaining connectivity and service quality. These network operations may include, for example, performance monitoring, fault detection and resolution, service onboarding and provisioning, configuration management, security assurance, and the like, across different network domains. In this regard, various types of applications are employed in the telecommunication network, each of the applications may have specialized functionalities for managing a specific network operation. These applications may be accessible and utilized by a user (e.g., a network operator, a network administrator, etc.) to manage the network operations in the telecommunication network.

### SUMMARY

Example embodiments of the present disclosure provide devices, systems, methods, and the like, that utilize one or more AI-related features to enable effective and efficient network operation management.

According to example embodiments, a device may be configured to: receive a prompt associated with a telecommunication network; determine, via a Natural Language Processing (NLP) operation, an intent of the prompt; generate, via a Retrieval-Augmented Generation (RAG) operation, an enriched prompt that may include information associated with the determined intent; determine a category of the enriched prompt; select, from among a plurality of services, a service associated with the determined category; and provide the selected service based on the enriched prompt.

According to example embodiments, a method may include: receiving a prompt associated with a telecommunication network; determining, via an NLP operation, an intent of the prompt; generating, via an RAG operation, an enriched prompt that may include information associated with the determined intent; determine a category of the enriched prompt; selecting, from among a plurality of services, a service associated with the determined category; and providing the selected service based on the enriched prompt.

According to example embodiments, a system may include: a first device and a second device. The first device may be configured to: receive a prompt associated with a telecommunication network; determine, via an NLP operation, an intent of the prompt; generate, via an RAG operation, an enriched prompt that may include information associated with the determined intent; determine a category of the enriched prompt; and output the enriched prompt according to the determined category. The second device may be configured to: receive, from the first device, the enriched prompt; and provide a service based on the enriched prompt.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a diagram of an example configuration for implementing an OSS in the related art;

FIG. 2 illustrates a diagram of an example system architecture, according to one or more example embodiments;

FIG. 3 illustrates a diagram of an example system configuration of an example use case, according to one or more example embodiments;

FIG. 4A to FIG. 4D illustrate an example UI configured to engage in a conversation with a user, according to one or more example embodiments;

FIG. 5 illustrates a block diagram of an example method for processing a prompt, according to one or more example embodiments;

FIG. 6 illustrates a block diagram of an example method for determining the intent of a prompt, according to one or more example embodiments;

FIG. 7 illustrates a block diagram of an example method for generating an enriched prompt, according to one or more example embodiments;

FIG. 8 illustrates a block diagram of an example method for engaging with a UE, according to one or more example embodiments;

FIG. 9 illustrates a block diagram of an example method for providing a Text-to-SQL service, according to one or more example embodiments;

FIG. 10 illustrates a block diagram of an example method for providing a virtual assistant service, according to one or more example embodiments;

FIG. 11 illustrates a block diagram of an example method for providing an assisted operation service, according to one or more example embodiments;

FIG. 12 illustrates a block diagram of an example device for implementing one or more example embodiments; and

FIG. 13 illustrates a block diagram of an example environment for implementing one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that one or more of the systems and methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc. In addition, expressions such as “a processor may be configured to perform an operation,” are to be understood as the processor may be configured to execute computer-executable instructions or programming codes to thereby perform an operation. Namely, the instructions or programming codes may be configured to cause the processor to perform an operation.

In the present disclosure, specific tasks may be performed using AI/ML (Artificial Intelligence/Machine Learning) models. An AI/ML model is a model generated using one or more AI technologies, one or more ML algorithm, or both, and generates output data based on input data. This output data is used to perform tasks. Tasks performed using AI/ML models include those generally referred to as intellectual tasks, such as classification, prediction, natural language processing, etc.

Although AI and ML are explained separately, ML is a technology included in AI. In ML, instead of being explicitly programmed for a specific task, systems can improve their performance over time by identifying patterns and making inferences from training data. Typically, the generation of ML models includes data collection, model training, and model inference. Data collection involves gathering and preprocessing data to be used for training and inference. Model training involves developing and validating models using the collected data. Model inference involves applying the trained models to new data to generate new output data and perform tasks.

Machine learning includes various types of learning methods such as supervised learning, unsupervised learning, reinforcement learning, semi-supervised learning, self-supervised learning, transductive learning, transfer learning, meta learning, and the like. These types of learning methods can be appropriately selected according to the embodiments. Unless otherwise specified, the application of types not mentioned in this description is not precluded. Additionally, the structure of ML models may vary depending on the embodiments and learning methods, and is not limited to the methods disclosed. Furthermore, ML includes deep learning, which uses models that include neural networks. Deep learning models may include, for example, deep neural networks (DNNs), convolutional neural networks (CNNs), etc.

It should be noted that the AI/ML models presented hereinafter are examples and are not limited to the illustrated AI/ML models. They can be modified or altered by using different AI or ML algorithms. The configuration of the neural network is not limited to the configuration disclosed in the present disclosure and can be modified.

As described above, various applications may be implemented in a telecommunication network for network operation management purposes. In this regard, an Operations Support System (OSS) may be utilized in a telecommunication network to provide a comprehensive platform that hosts various types of software applications and software tools, each of which may provide operational support to a user (e.g., a network operator, a network administrator, etc.) to manage network operations. Specifically, one or more of the applications in the OSS may provide specialized functionalities across different network domains, enabling the user to manage different network operations by interacting with the associated application(s) in the OSS. Accordingly, the OSS provides a centralized platform that enables the user to manage (e.g., monitor, control, optimize, etc.) network operations without the need for direct interaction with the network elements.

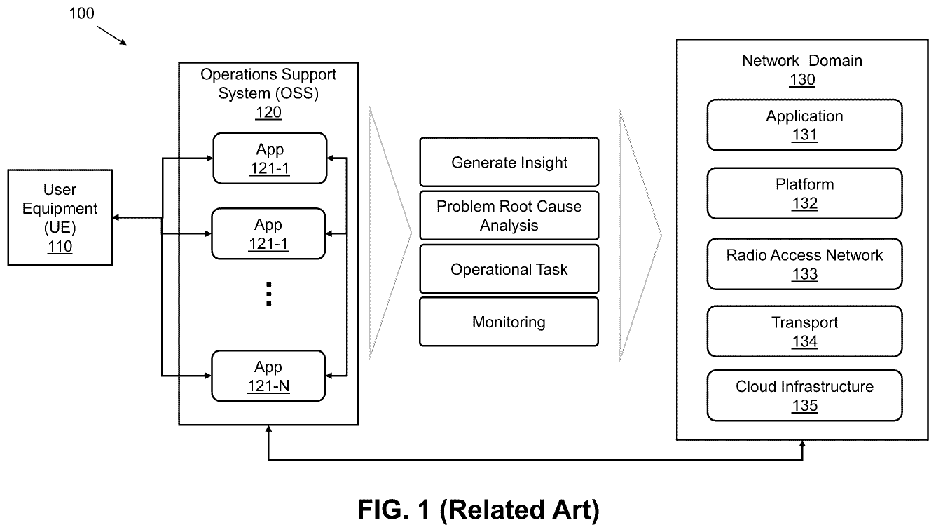

FIG. 1 illustrates a diagram of an example configuration 100 for implementing an OSS in the related art. As illustrated in FIG. 1, the implementation may involve a user equipment (UE) 110, an OSS 120, a network domain 130.

The UE 110 may be a device or an equipment utilized by a user (e.g., network operator, network administrator, etc.) to access the OSS 120 and utilize an application implemented therein to manage a network operation in the network domain 130. The OSS 120 may implement multiple applications 121-1 to 120-N (where N is any natural value), each of which may interact with the network domain 130 and have a specific functionalities (e.g., performance monitoring, fault detection, etc.) for maintaining a network operation therein. The network domain 130 may include different infrastructural layers of a telecommunication network, i.e., application 131 may refer to the layer in which the network applications and services are implemented, platform 132 may refer to the layer in which the platforms and middleware associated with the network applications/services are implemented, radio access network (RAN) 133 may refer to the layer that managers wireless communication between the UE 110 and a base station, transport 134 may refer to the layer that manages the data transmissions across the network, and cloud infrastructure 135 may refer to the layer that manage the network resources.

Generally, the UE 110 may access the OSS 120 and interact with one or more applications hosted on the OSS 120, thereby managing the network operations of one or more layers of the network domain 130. For instance, the UE 110 may utilize a first application in OSS 120 to generate insight on a service implemented in the application 131, utilize a second application in OSS 120 to perform root cause analysis on the RAN 133, utilize a third application to perform operational task on the transport 134, utilize a fourth application to monitor the network resource condition in the cloud infrastructure 135, and the like. By leveraging the OSS 120 and the applications hosted thereon, the UE 110 can indirectly manage network operations of the telecommunication network. Nevertheless, as described below, network operation management through the OSS in the related art possess several issues.

Specifically, although the applications are being collectively hosted on the OSS and may interoperate with each other at the backend, the applications may each has a dedicate user interface (UI) of its own that does not have correlation with the UI of other applications. The fragmentation of UIs forces the user to switch between different applications and separately interact with different UIs (e.g., whenever the user would like to perform management on different aspects of network operations, etc.), regardless of whether the network operations are interrelated. As a result, the user may need to manually perform repetitive tasks across multiple UIs (e.g., manually re-entering the same information or data into multiple UIs, etc.), leading to the increased risk of data inconsistencies, potential human errors, and increased user's workload.

Further, since there is no correlation between the UIs, the same or related information may be presented differently in each UI. For instance, during root-cause analysis of a network fault, the user may need to manually review information across different UIs to identify issues and the reasons therefrom. In this regard, if the same or related information are presented differently (e.g., different presentation or descriptive styles, different levels of details, etc.) in different UIs, it may be difficult for the user to quickly and accurately correlate information across different UIs and obtain a comprehensive view of the related network information. As a result, the user may unable to timely obtain critical information (e.g., early network failure warning signs, etc.) and make timely and accurate decision, eventually leading to delayed-response time and escalation of network issues.

Furthermore, since different UIs may have distinct interaction paradigms and functionalities, the user is forced to invest time and resources into learning, training, and familiarizing with different UIs. For instance, the user needs to learn different command sets, workflow, and terminologies specific to each UI. As a result, a new (or less experienced) user may face a steep learning curve and often require extensive training and supervision when utilizing the applications of OSS to perform network operation management. This also caused the tendency of the network operators to rely mainly on highly experienced users to perform network operation management, which elevates operational overhead and restricts scalability as network complexity grows and the number of applications (and hence the UIs) in the OSS increases.

In addition to the challenges caused by fragmented UIs, the significant number and diversity of available applications may be overwhelming and confusing for the users. Particularly, some applications may have overlapping functionalities or similar capabilities (e.g., both a fault monitoring application and a performance analysis application may display network key performance indicators (KPIs), an application dedicated to RAN and an application dedicated to a cloud infrastructure may both offer resource management features, etc.). This overlap may lead to confusion, particularly when the user is new or inexperienced, when a new application is on-boarded to the OSS, and the like. Thus, the user may rely on trial and error to determine the application that best fits to the requirements. Additionally, certain network elements may require control or management via specialized applications (e.g., applications that support vendor-specific protocols, etc.). In view of the above, if the user is unaware of the distinctions among different applications, the user may inadvertently utilize the wrong application for network operation management, resulting in ineffective management and, in the worst case, unintended network issues.

On the other hand, while each UI and application may be designed to accommodate the specialized functionalities of the associated applications, there is no consolidated interface that handles generic tasks such as overall status queries, information retrieval, general questions and answers (e.g., questioning the meaning of a specific terminology, etc.), and the like. As a result, the user may need to manually research or reconcile the required data from different sources or platforms, leading to inconvenience and inefficiencies in performing network operation management.

Example embodiments of the present disclosure provide a system, a device, a method, and the like, that implement one or more AI-related features in network operation management, thereby enabling effective and efficient network operation management and ultimately solving the above-described issues in the related art.

Specifically, example embodiments of the present disclosure implement a device (or a system that includes one or more devices) that may be configured to interact with a user equipment (UE) to present a UI to a user and receive a prompt from therefrom, and then provide various types of services (e.g., data retrieval service, virtual assistant service, assisted operation service, etc.) based on the user-provided prompt. According to example embodiments, the device may (or the system may include a device that may) implement one or more AI technologies or features, such as Natural Language Processing (NLP) and Retrieval-Augmented Generation (RAG), to process the prompt, thereby determining the intent of the prompt, enriching the prompt to clarify/supplement the intent, selecting a suitable service that is associated with the enriched prompt, and providing the selected service based on the enriched prompt. Subsequently, the UI presented to the user may be updated to present thereon a response to the prompt.

As a result, example embodiments enable the users to seamlessly perform various types of tasks (from generic tasks like inquiry about a network status to specific tasks to manage a network operation) via interacting with a single UI, without the need to switch between different UIs and manually perform repetitive tasks across different UIs. Thus, the risk of data inconsistency and human errors, as well as the workload of the user in managing network operations, may be effectively reduced. In addition, since the information of different services and applications (if applicable) are collectively presented on a single UI, said information may be presented in a uniform and intuitive manner, enabling the user to quickly and accurately obtain key information therefrom and improving decision-making and troubleshooting efficiency.

Further, example embodiments also enable the users to perform network operation management by simply inputting high-level, generic information (e.g., the intended operation(s), the target/objective, etc.) into the UI in any technical level (e.g., from generic natural language to specific operation command). By leveraging AI technologies (e.g., NLP and RAG), the intent of the prompt may be automatically and accurately determined, and the intent may be further clarified/specified in an enriched prompt (which will be utilized for selecting and providing an appropriate service). Accordingly, example embodiments do not require the users to be familiarized with the back-end applications, since example embodiments do not require the users to manually decide or select which application to utilize (although the users may still decide or select a specific application by specifying the same in the prompt). As a result, example embodiments effectively reduce the complexity of managing different network operations and minimize the need for extensive specialized training, thereby enabling any authorized personnel (including new or less experienced users) to be involved in the network operation management, increasing the scalability and flexibility of the network operation management, and reducing the operational cost associated therewith.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of the example embodiments of the present disclosure are provided in the following.

### Example System Architecture

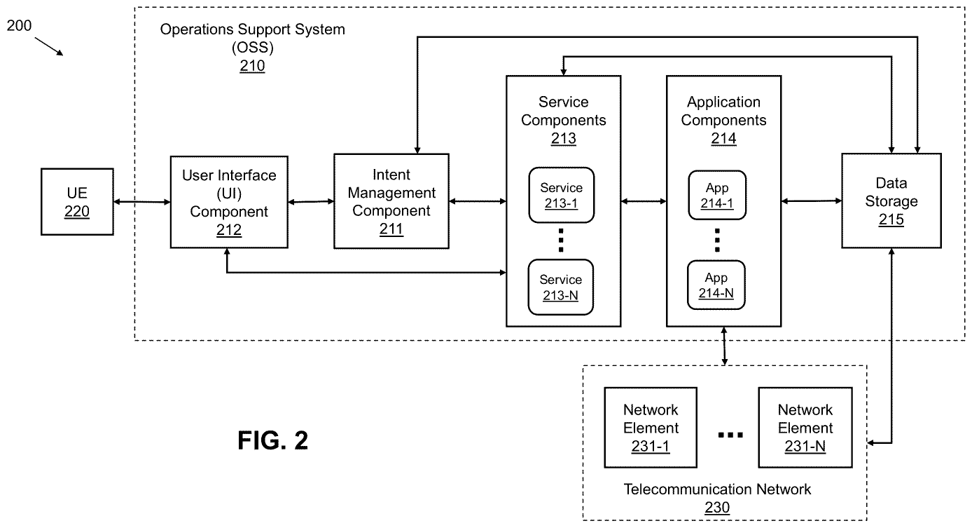

FIG. 2 illustrates a diagram of an example system architecture 200, according to one or more example embodiments. As illustrated in FIG. 2, the system architecture 200 may include an Operations Support System (OSS) 210, a User Equipment (UE) 220, and a Telecommunication Network 230.

The OSS 210 may consist of various components, such as an Intent Management Component 211, a User Interface (UI) Component 212, a plurality of Service Components 213, a plurality of Application Components 214, and a Data Storage 215. One or more of the components 211-215 may be implemented in the same device or different devices, such as a server(s), a terminal(s), and the like. The Telecommunication Network 230 may consist of a plurality of Network Elements 231-1 to 231-N (where N is any natural number).

The operations involved the system architecture 200 may be segmented into several stages, such as: the prompt reception stage, the intent processing stage, the service provisioning stage, the application execution stage, and the network operation management stage. Generally, at the prompt reception stage, the UI Component 212 may generate and present a UI to a user via the UE 220, thereby enabling the user to provide a prompt including a request or inquiry associated with the Telecommunication Network 230. As further described below, the prompt may be in any form (e.g., from natural language to specific structured command) and may be associated with any tasks related to the Telecommunication Network 230 (e.g., from a general inquiry to a specific network operation management).

Upon receiving the prompt, the UI Component 212 may forward the prompt to the Intent Management Component 211, thereby initiating the intent processing stage. Specifically, the Intent Management Component 211 may implement one or more AI features/technologies (e.g., NLP, RAG, etc.) to determine an intent of the prompt, enrich the prompt based on the determined intent, determine a category of the enriched prompt, select at least one of the Service Components 213-1 to 213-N (where N is any natural number) based on the category of the enriched prompt, and send the enriched prompt to the selected Service Component(s) 213.

Accordingly, at the service provisioning stage, the selected Service Component(s) 213 may provide a service based on the enriched prompt. The service provisioning may or may not involve at least one of the Application Components 214-1 to 214-N (where N is any natural number), the Data Storage 215, and at least one of the Network Elements 231-1 to 231-N. If the service provisioning involves at least one of the Application Components 214-1 to 214-N, the application execution stage may be initiated, in which the selected Service Component(s) 213 may select at least one of the Application Components 214-1 to 214-N and instruct the selected Application Component(s) to implement or perform an operation on at least one of the Network Elements 231-1 to 231-N. Subsequently, at the network operation management stage, the selected Application Component(s) may perform one or more operations to manage the associated Network Element(s).

One or more of components 211-215 may be implemented in the same device/platform or in a different device/platform. For instance, the Intent Management Component 211 and the UI Component 212 may be implemented in the same device/platform, and the like. Further, it is contemplated that one or more of components 211-215 may include additional components or functional units, without departing from the scope of the present disclosure. Furthermore, one or more of the components 211-215 may be implemented in software form, hardware form, or a combination thereof. Specifically, a “component” described herein may refer to computer-readable instructions or software programming codes that, when being executed by a processor (or any other suitable computing units), enable the processor to perform or implement one or more of the associated operations. Alternatively or additionally, a “component” described herein may also refer to a hardware component, such as a device, a system, and the like, that may be configured to (or may execute computer-readable instructions/software programming codes to) perform or implement one or more of the associated operations.

The UE 220 may include any suitable device or equipment through which a user may utilize to access the OSS 210. The communication between the UE 220 and the OSS 210 may be performed over secure channels, via a wireless connection, wired connection, or a combination thereof. The “user” described herein may include a network operator, a network administrator, an engineer, and any other suitable personnel that is authorized to access the OSS 210. In this regard, the UE 220 may include one or more hardware devices, such as a workstation, a personal computer (PC), a tablet, a smartphone, a service, a dedicated terminal, and the like. Additionally or alternatively, the UE 220 may include one or more software tools, such as a web application, a mobile application, an integrated client software, and the like, that is hosted or implemented in a hardware device.

According to example embodiments, the UE 220 may generate and present, to the associated user, a UI provided by the UI Component 212. Specifically, the UE 220 may generate and present the UI to the user, thereby enabling the user to submit a query, command, instruction, or request associated with at least one of the OSS 210 and the Telecommunication Network 230 (may collectively referred to herein as a “prompt”) whenever the user wishes to perform an associated operation (e.g., network operation management, network status inquiry, etc.). The prompt may be in the form of natural language, specific commands/instructions, or a combination thereof. In some example implementations, the user may provide an audio input (e.g., a voice or sound stream) via the UI, which at least one of the UE 220 and UI Component 212 processes to generate a corresponding text prompt. According to example embodiments, the UE 220 may update a UI to present updated information (e.g., a response to the prompt, etc.) to the user thereon.

The UI Component 212 may generate, present, and update a UI. In some example embodiments, the UI Component 212 may provide, to the UE 220, data required for the generation, presentation, and update of the UI, thereby enabling the UE 220 to generate, present, and update the UI thereon. In this regard, the UI may refer to an intuitive, consolidated interface that may be configured to engage users of all backgrounds at the front-end. Specifically, the UI enables users to input prompts with varying levels of detail, ranging from generic prompts to highly specific prompts. Further, the UI also enables the users to input prompts in any language, such as natural language, specific commands, and the like. In addition, the UI also enables the users to input prompts in various formats, such as text and audio. According to example embodiments, the UI Component 212 may receive, from the UE 220, a prompt that contains text data, audio data, or a combination thereof. In this regard, whenever the UI Component 212 receives audio data, the UI Component 212 may convert the audio data into a corresponding text prompt via any suitable speech-to-text (STT) operation, such as utilizing acoustic and language models, speech template matching, and the like. Similarly, when the UI Component 212 receives a prompt that includes both audio data and text data, the UI Component 212 may convert the audio data into the corresponding text data and then combine the converted text data with the existing text data to form the text prompt.

Upon receiving the prompt from the UE 220 via the UI and processing the prompt (if the prompt includes audio data, etc.), the UI Component 212 may forward the prompt to the Intent Management Component 211 for further processing and may simultaneously update the UI to provide visual feedback thereon, notifying the user that the prompt is being processed. After the back-end operations are completed, the UI Component 212 may receive a response to the prompt and update the UI accordingly, thereby displaying the response thereon. For instance, the UI Component 212 may update the UI to display a summary of the implementation of an operation, present the requested data in visualized form, providing an answer to a query in natural language, and the like.

After receiving the prompt from the UI Component 212, the Intent Management Component 211 may perform various operations based on the prompt. The operations may be segmented into four main stages, i.e., the intent determination stage, the prompt enrichment stage, the prompt classification stage, and the prompt routing stage. In this regard, the Intent Management Component 211 may utilize one or more AI/ML models, technologies, or features in one or more operations of these four stages. In this regard, although it is described hereinbelow that the Intent Management Component 211 may implement Natural Language Processing (NLP) and Retrieval-Augmented Generation (RAG), it is contemplated that any other similar or suitable AI/ML models or technologies may be utilized or implemented in a similar manner, without departing from the scope of the present disclosure. Further, one or more operations of one or more of these four stages may, but not necessarily, be performed by implementing a dedicated sub-component of the Intent Management Component 211 (e.g., one or more operations of the intent determination stage may be performed or implemented by a first sub-component, while one or more operations of the prompt classification stage may be performed or implemented by a second sub-component, etc.).

The intent determination stage may be initiated by the Intent Management Component 211 upon receiving the prompt from the UI Component 212. At this stage, the Intent Management Component 211 may determine, via natural language processing (NLP), an intent of the prompt. In this regard, NLP described herein may refer to a subfield of AI/ML technology that enables a computing device to understand, interpret, and generate an output in human language, such as natural language. In the context of intent determination, the Intent Management Component 211 may input the prompt into an NLP model and obtain an output (which includes an intent classification of the prompt) therefrom. In this regard, the intent classification may refer to a parameter, an indication, or a result output by the NLP model that indicates the specific category or class of the prompt intent (e.g., generic inquiry, data retrieval request, etc.). Accordingly, the Intent Management Component 211 may determine, based on the intent classification obtained from the NLP model, the intent of the prompt.

According to example embodiments, the NLP model may include one or more rule-based or statistical models, such as a Hidden Markov model, Maximum Entropy model, and the like. Additionally or alternatively, the NLP model may include one or more deep learning-based models, such as an RNN model and a large language model (LLM) like a Bidirectional Encoder Representations from Transformer (BERT) model, Generative Pre-trained Transformer (GPT) model, Text-to-Text Transfer Transformer (T5) model, and the like. It is contemplated that the NLP model may include any other type of models (e.g., hybrid models, etc.) that can be utilized by the OSS 210 for NLP purposes. Furthermore, the NLP model may be pre-trained, fine-tuned, and regularly updated with domain-specific data of the Telecommunication Network 230 (e.g., data associated with the application layer, platform layer, RAN layer, transport layer, cloud infrastructure layer, etc.), thereby improving the ability of the NLP model to effectively, efficiently, and accurately process the user prompts.

According to example embodiments, the Intent Management Component may implement the NLP model to determine the intent of the prompt by: tokenizing each text contained in the prompt, generating one or more embeddings that capture the semantic meaning of the tokenized text(s), and feeding the embedding(s) into the NLP model. Accordingly, the NLP model may compare the embedding(s) against a set of pre-defined intent classes, and then classify the embedding(s) based thereon. The classification of the embeddings may involve the utilization of a trained classifier (such as a classifier based on a transformer architecture, etc.) that calculates a probability distribution over the possible intent classes. Accordingly, the intent of the intent class that has the highest probability may then be selected as the classification result. The classification accuracy may be enhanced by fine-tuning the NLP model with domain-specific data from the Telecommunication Network 230.

As a non-limiting example, assuming that the prompt contains texts in natural language, such as “Tell me about RAN.” In this case, each of the terms “Tell,” “me,” “about,” and “RAN” may be tokenized by the Intent Management Component 211, and an associated embedding for each tokenized text may then be generated and fed by the Intent Management Component 211 into an NLP model. In this regard, since the NLP model is fine-tuned with data of the telecommunication network, the NLP model may determine that the intent of “RAN” in the prompt has the highest probability of being a “Radio Access Network,” and some other possible interpretations of “RAN” (e.g., the past tense of the verb “run,” the code for the Ravenna Airport in Italy, etc.) would have a lower probability distribution. Accordingly, the NLP model may determine that the intent of the prompt is, for example, “an inquiry for the general information of a Radio Access Network (RAN).” Accordingly, the NLP model may output an intent class, and the Intent Management Component 211 may determine the intent of the prompt based thereon.

Upon determining the intent of the prompt, at the prompt enrichment stage, the Intent Management Component 211 may generate an enriched prompt that includes additional information associated with the determined intent of the prompt. In some example embodiments, the Intent Management Component 211 may generate the enriched prompt via a retrieval-augmented generation (RAG) operation. Specifically, the Intent Management Component 211 may access a data storage that stores information (e.g., configuration settings, historical fault logs, etc.), files (e.g., technical files), documents (e.g., network element documents), and the like (collectively referred to as “data” herein) associated with the Telecommunication Network 230, and then retrieve data associated with the determined intent of the prompt therefrom. Accordingly, the Intent Management Component 211 may integrate the retrieved data with the prompt to obtain the enriched prompt. The data storage may be implemented internally as a part of the Intent Management Component 211 or externally from the Intent Management Component 211. According to example embodiments in which the data storage comprises a plurality of data storages, a portion of the plurality of data storages may be implemented in the Intent Management Component 211, while another portion of the plurality of data storages may be implemented externally from the Intent Management Component 211.

According to example embodiments, the data storage may be implemented as a vector database that serves as a dynamic knowledge base. The data storage may be regularly updated with the latest data. The data may be converted into vector representations (or embeddings) that capture and summarize the semantic content and key information of the data/files. It can be understood that the embedding(s) generated during the intent determination stage may also be utilized at this stage to query the vector database for relevant data. In this regard, at the prompt enrichment stage, the Intent Management Component 211 may convert the prompt and the determined intent into an embedding that summarizes the semantic content and the key information of the prompt (and the determined intent, in some example implementations), and utilize the embedding to search the vector database for the associated data (e.g., by comparing the generated embedding with the embeddings of the stored data, etc.). The data that has the embedding(s) that achieve the highest similarity scores are then retrieved by the Intent Management Component 211. The retrieved data may then be integrated with the original prompt to form the enriched prompt, which contains both the content of the original prompt and the context-specific (i.e., telecommunication-specific) data that specify, clarify, and supplement the intent of the original prompt.

As a non-limiting example, assuming that the prompt is “What is the network latency at network cell A” and the determined intent is “an inquiry for performance metrics of a network cell”. The Intent Management Component 211 may convert the prompt and the intent into one or more embeddings and then search the data storage (e.g., vector database) for data with the embedding(s) associated with “network cell A” (e.g., data showing that network elements X and Y are operating within network cell A, etc.) while prioritizing data with the embedding(s) associated with “performance metrics” (e.g., performance metrics for the last 30 minutes are available, etc.). Accordingly, the retrieved data may be integrated with the original prompt to produce an enriched prompt, such as “a request to retrieve the network latency at network cell A for the last 30 minutes, which is the combination of the latencies of network element X and network element Y for the last 30 minutes”.

Upon generating the enriched prompt, a the prompt classification stage, the Intent Management Component 211 may be configured to determine a category of the enriched prompt. According to example embodiments, the Intent Management Component 211 may determine the category based on a set of predefined mappings, via NLP, or a combination thereof. For instance, the Intent Management Component 211 may determine a keyword(s) in the enriched prompt and then compare the determined keyword(s) with a mapping that specifies the relationships between a plurality of keywords and a plurality of categories. Additionally or alternatively, the Intent Management Component 211 may input the enriched prompt into an NLP model (which may be the same or different NLP model involved at the intent determination stage) and obtain an output that indicates the category of the enriched prompt therefrom. In this case, the Intent Management Component 211 may combine the embeddings of the original prompt (generated at the intent determination stage) and the embeddings of the data (retrieved at the prompt enrichment stage) to obtain the embedding(s) of the enriched prompt, and then input the embedding(s) of the enriched prompt into the NLP model.

According to example embodiments, the category of the enriched prompt may associated with a service provided or managed by at least one of the Service Components 213-1 to 213-N. For instance, the category of the enriched prompt may include a data retrieval category (which may be associated with a service that retrieves data from the Data Storage 215, such as a Text-to-SQL (Structured Query Language) service), a generic response category (which may be associated with a service that responds to general inquiries in a conversational manner, such as a Chatbot or a Virtual Assistant service), an operational instruction category (which may be associated with a service that interacts with an application to manage a network element), a content generation category (which may be associated with a service that generates content like images, videos, documents, etc.), and any other suitable type of categories.

Upon determining the category of the enriched prompt, at the prompt routing stage, the Intent Management Component 211 may select, from among the Service Components 213-1 to 213-N, a Service Component associated with the determined category. In this regard, one or more of the Service Components 213-1 to 213-N may refer to a device, component, system, and the like, that may be configured or implemented to provide or manage a service according to the enriched prompt. Additionally or alternatively, one or more of the Service Components 213-1 to 213-N may refer to a service, application, and the like, that may be implemented by a device (e.g., a same/different device that implements the Intent Management Component 211, etc.). For instance, the Service Components 213-1 to 213-N may include a Service Component that provides data retrieval service (e.g., Text-to-SQL service, etc.), a service that responds to general inquiries in a conversational manner (e.g., Chatbot service, Virtual Assistant service, etc.), a service that interacts with one or more applications (e.g., interacting with one or more of the Application Components 214-1 to 214-N via one or more application programming interfaces (APIs), etc.), a service that generates contents (e.g., images, videos, documents, etc.) based on the enriched prompt, and any other suitable type of services. Upon selecting the Service Component, the Intent Management Component 211 may send the enriched prompt to the selected Service Component for further processing.

Upon receiving the enriched prompt from the Intent Management Component, the selected Service Component may be configured to provide a service based on the enriched prompt. According to example embodiments, the selected Service Component may be configured to provide at least one of: a data retrieval service (e.g., a Text-to-SQL service), a general inquiry service (e.g., a Virtual Assistant service), an assisted operation service (e.g., a service to interact with application's API), and any other suitable type of services.

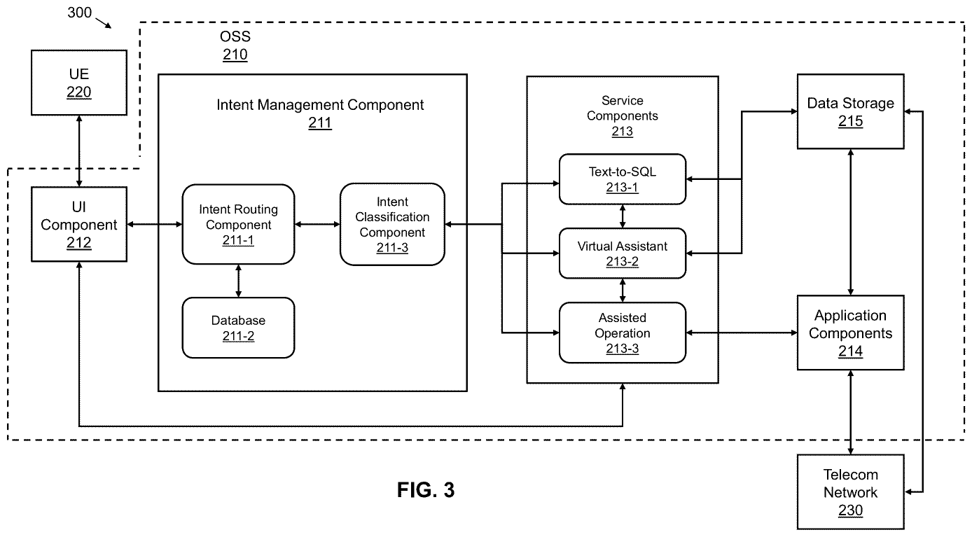

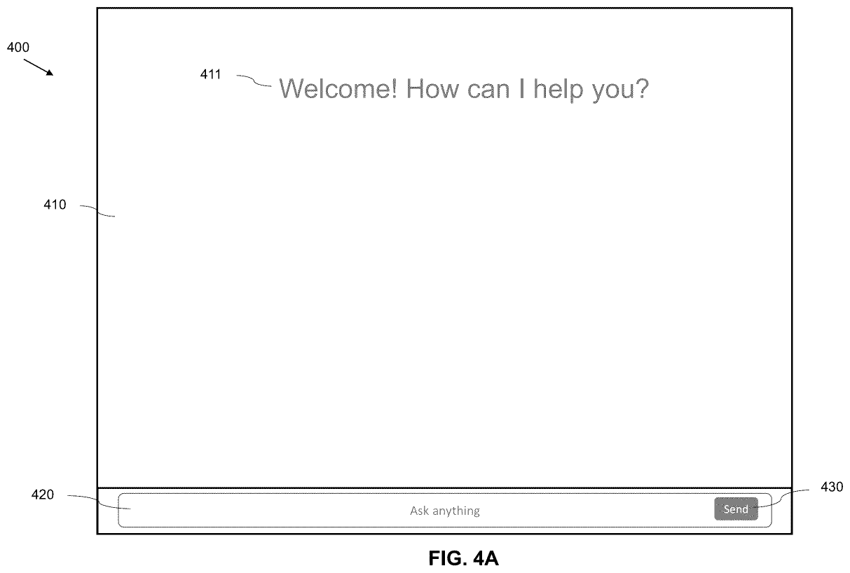

According to example embodiments, if the prompt (and the enriched prompt) is associated with service(s) that does not involve any of the Application Components 214-1 to 214-N, the selected Service Component may provide the service (e.g., retrieve data, generate an answer to general inquiry, etc.) and provide a response to the prompt (e.g., including the retrieved data, the generated answer, etc.) to the UI Component 212 thereafter, such that the UI Component 212 may update the UI to present the response to the user via the UE 220. On the other hand, the if prompt (and the enriched prompt) is associated with service(s) that involves one or more of the Application Components 214-1 to 214-N, the selected Service Component may provide an assisted operation service based on the enriched prompt. Specifically, the Service Component may select, from the Application Components 214-1 to 214-N, an Application Component associated with the enriched prompt. Subsequently, the Service Component may generate, based on the enriched prompt, an instruction readable by the selected Application Component to implement the operation. Accordingly, the Service Component may provide the generated instruction to the selected Application Component. After the selected Application Component has performed or implemented an operation(s) according to the instruction, the Service Component may receive a result of the implementation of the operation from the selected Application Component. Subsequently, the Service Component may provide the result of the implementation of the operation to the UI Component 212, such that the UI Component 212 may update the UI to present the result to the user via the UE 220. Further descriptions of several example services, as well as the operations associated therewith, are provided below with reference to FIG. 3 and FIGS. 4A to 4C.

Referring still to FIG. 2, each of the Application Components 214 may refer to a device, component, system, and the like, that may be communicatively coupled to at least one network element in the Telecommunication Network 230 (e.g., at least one of the Network Elements 231-1 to 231-N) and be configured to perform or implement an operation associated with the at least one network element according to the instruction provided by an associated Service Component. For instance, one or more of the Application Components 214-1 to 214-N may read the instruction provided by the selected Service Component and implement a specific operation on the associated network element(s), thereby managing a network operation of the associated network element(s).

According to example embodiments, one or more of the Application Components 214-1 to 214-N may be configured to implement at least one of: an operation associated with fault management (e.g., monitoring alarms and faults in the associated network element(s), logging incident data, initiating trouble shooting process, etc.), an operation associated with performance monitoring (e.g., monitoring KPIs of the associated network element(s), assessing network performance trends, etc.), an operation associated with configuration management (e.g., verifying configuration changes on the associated network element(s), applying or instructing the associated network element(s) to apply configuration changes, etc.), an operation associated with resource provisioning (e.g., allocating network resources to the associated network element(s), scaling-up/scaling-down the associated network element(s), etc.), an operation associated with security management (e.g., enforcing security policies on the associated network element(s), managing access controls, detecting potential vulnerabilities within the associated network element(s), etc.), an operation associated with inventory management (e.g., obtaining up-to-date data from the associated network element(s) and update the data into the Data Storage 215, etc.), an operation associated with lifecycle management (LCM) of a virtualized or containerized network function (e.g., handling the provisioning, deployment, scaling, monitoring, upgrading, and decommissioning of the virtualized/containerized network function of the associated network element(s), etc.), an operation associated with energy-saving (e.g., adjusting the discontinuous reception (DRX) configuration of the associated network element(s), etc.), and any other suitable operations for managing the associated network element(s).

According to example embodiments, one or more of the Application Components 214-1 to 214-N may be communicatively coupled to the Data Storage 215 and configured to utilize, read, write, modify, or delete data in the Data Storage 215. For instance, an Application Component responsible for performance monitoring may store data associated with the monitored KPIs in the Data Storage 215 and may periodically (or continuously) update the data of the monitored KPIs in the Data Storage 215. As another example, an Application Component responsible for security management may read data stored in the Data Storage 215 (e.g., data associated with security policies, historical logs, vulnerability reports, etc.) and implement security-related operations based thereon.

According to example embodiments, the components in the OSS 210 (e.g., Intent Management Component 211, UI Component 212, Service Components 213, Application Components 214, Data Storage 215, etc.) may be implemented in the same device (e.g., in the same server, etc.). In this case, it can be understood that the device may be configured to perform one or more operations of one or more components of the OSS 210 in a similar manner as described herein, without departing from the scope of the present disclosure. For instance, the device may be configured to perform one or more of: presenting a UI to the UE 220, receiving a prompt from the UE 220, processing the prompt (e.g., determining an intent of the prompt, generating an enriched prompt based on the determined intent, determining a category of the enriched prompt, etc.), selecting a service associated with the prompt (e.g., a service associated with the determined category of the enriched prompt, etc.), providing the selected service (e.g., based on the enriched prompt), updating the UI to present a response to the prompt, and the like.

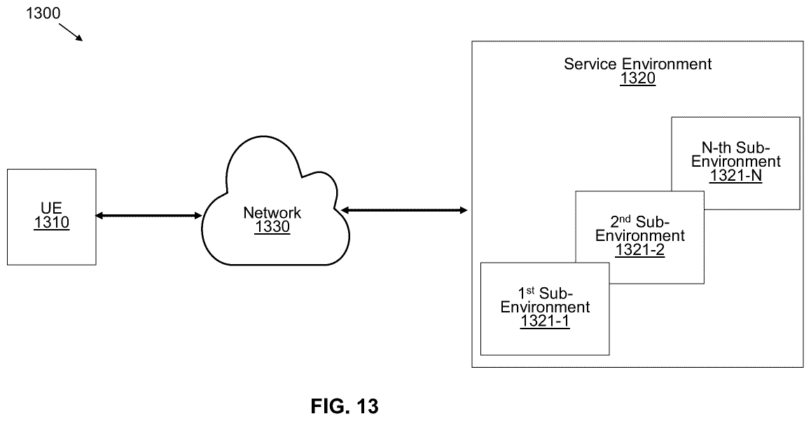

Referring still to FIG. 2, the Telecommunication Network 230 may include any suitable type of network that facilitates information and data transmission via one or more electrical or electronic components. For instance, the Telecommunication Network 230 may include a cellular network, a public land mobile network (PLMN), a local area network (LAN), a wide area network (WAN), a metropolitan area network (MAN), a telephone network, a private network, an ad hoc network, an intranet, the Internet, a fiber optic-based network, or the like, a non-terrestrial network (NTN), or a combination of these or other types of networks. Descriptions of several examples of Telecommunication Network 230 are provided below with reference to FIG. 13.

As illustrated in FIG. 2, the Telecommunication Network may consist of a plurality of Network Elements 231-1 to 231-N. These Network Elements 231-1 to 231-N may be implemented in various forms, such as software form, hardware form, or a combination thereof. For instance, one or more of the network elements 231-1 to 231-N may include a virtualized or containerized network function, a software application (e.g., rApp or xApp operating within a RAN Intelligent Controller (RIC), etc.), and the like. Additionally or alternatively, one or more of the network elements 231-1 to 231-N may include one or more hardware components or devices (e.g., antennas, routers, switches, etc.) that may include an embedded computing unit and firmware that communicates with one or more of the Application Components 214. Each of the Network Elements 231-1 to 231-N may be associated with one or more network layers (e.g., application layer, platform layer, RAN layer, transport layer, cloud infrastructure layer, etc.) of the Telecommunication Network 230.

According to example embodiments, one or more of the Network Elements 231-1 to 231-N may be communicatively coupled to the Data Storage 215. In this regard, one or more of the Network Elements 231-1 to 231-N may periodically (or continuously) provide data (e.g., performance metrics, configuration details, event logs, KPIs, etc.) to the Data Storage 215, in real-time, near-real-time, or non-real-time.

Referring still to FIG. 2, the Data Storage 215 may be communicatively coupled to the Intent Management Component 211, one or more of the Service Components 213-1 to 213-N, one or more of the Application Components 214-1 to 214-N, and one or more of the Network Elements 231-1 to 231-N. In this regard, the Data Storage 215 may serve as a centralized database that receives data from and provides data to these components and elements, enabling them to obtain and communicate updated data for the required operations. For instance, the Data Storage 215 may provide data to and receive data from the Intent Management Component 211 during the intent determination stage, prompt enrichment stage, prompt classification stage, and prompt routing stage (e.g., provide data associated with the network element(s) to enrich the prompt, receive a classification result of an enriched prompt, etc.). Similarly, the Data Storage 215 may provide data to and receive data from one or more of the Service Components 213-1 to 213-N during the service provisioning stage (e.g., provide data associated with requested information, provide data for generating a generic response, receive data of a generated response, etc.), provide data to and receive data from one or more of the Application Components 214-1 to 214-N during the application execution stage (e.g., provide data associated with security policies for security management operations, receive data associated with updated configuration settings after the implementation of an operation, etc.), and provide data to and receive data from one or more of the Network Elements 231-1 to 231-N during the network operation stage (e.g., provide data associated with operational thresholds, receive data associated with status and performance of the network elements, etc.).

According to example embodiments, the Data Storage 215 may include multiple data storage devices or may be implemented with multiple data storage technologies. For instance, the Data Storage 215 may include multiple servers or databases, such as relational databases (e.g., SQL servers), data lakes, vector databases, and the like.

In view of the above, example embodiments provide a system, a device, and the like that enable a user to effectively and efficiently manage one or more network operations. Specifically, by integrating the Intent Management Component, UI Component, and various types of Service Components and Application Components in a device, a system, and the like, example embodiments consolidate user interactions into a single, unified UI that can seamlessly handle any type of task, from generic tasks (e.g., inquiry of general information, etc.) to specific tasks (e.g., schedule a specific operation to manage a specific network element, etc.). The processes of network operation management can be implemented via a conversation between the UI and the user, in which the user may enter prompts in natural language or as specific commands, receive context-aware responses, and provide feedback to refine the original prompt or additional prompt(s) to perform related tasks. This conversational approach leverages automated and intelligent processing, such as intent determination via NLP, prompt enrichment via an RAG operation, dynamic routing the enriched prompt to the appropriate Service Component(s), and the like, thereby ensuring that the correct actions are implemented with minimal user intervention, simplifying the network operation management, and enhancing overall network management efficiency.

It is contemplated that features, advantages, and significances of example embodiments described hereinabove with reference to FIG. 2 are merely a portion of the present disclosure, and are not intended to be exhaustive or to limit the scope of the present disclosure. Further descriptions of several example uses cases, in which the example embodiments associated with FIG. 2 may be implemented, are provided below.

### Example Use Cases

FIG. 3 illustrates a diagram of an example system configuration 300 of an example use case, according to one or more example embodiments. One or more components in this example use case (and the associated configurations, features, operations, etc.) may be similar to those described above with reference to FIG. 2. Thus, descriptions provided in the following are mainly associated with the additional features, and redundant descriptions of the similar features may be omitted below for conciseness.

As illustrated in FIG. 3, in this example use case, the Intent Management Component 211 may include an Intent Routing Component 211-1, a Database 211-2, and an Intent Classification Component 211-3. According to example embodiments, the Intent Management Component 211 may include a plurality of Intent Routing Components 211-1, a plurality of Databases 211-2, or a plurality of Intent Classification Components 211-3. Further, in the example use case of FIG. 3, the Service Components 213 may include a first Service Component 213-1 that provides or manages a Text-to-SQL service (“Text-to-SQL Service Component” herein), a second Service Component 213-2 that provides or manages a virtual assistant service (“Virtual Assistant Service Component” herein), and a third Service Component 213-3 that provides or manages an assisted operation service (“Assisted Operation Service Component” herein).

Referring to FIG. 3, the Intent Routing Component 211-1 may be communicatively coupled to the UI Component 212 and the Database 211-2. In this regard, the Intent Routing Component 211-1 may be configured to receive a prompt from the UI Component 212 and implement the operations of the intent determination stage and the prompt enrichment stage accordingly. Specifically, the Intent Routing Component 211-1 may determine an intent of the prompt (via an NLP operation, etc.) and generate an enriched prompt that includes additional information associated with the determined intent (via an RAG operation, etc.). During the prompt enrichment stage, the Intent Routing Component 211-1 may retrieve data from the Database 211-2 based on the determined intent of the prompt. In this regard, the Database 211-2 may serve as a knowledge base that stores data associated with the Telecommunication Network 230. Upon generating the enriched prompt, the Intent Routing Component 211-1 may direct the enriched prompt to the Intent Classification Component 211-3. According to example implementations where the Intent Management Component 211 includes a plurality of Intent Classification Components 211-3, the Intent Routing Component 211-1 may select an appropriate Intent Classification Component (e.g., based on the determined intent of the prompt, based on the available resources, etc.) and direct the enriched prompt to the selected Intent Classification Component.

The Intent Classification Component 211-3 may be configured to receive the enriched prompt from the Intent Routing Component 211-1 and implement operations of the prompt classification stage and prompt routing stage accordingly. Specifically, the Intent Classification Component 211-3 may be configured to determine a category of the enriched prompt (e.g., based on a set of predefined mappings, via NLP, etc.) and select at least one Service Component associated with the determined category. Accordingly, the Intent Classification Component 211-3 may route the enriched prompt to the selected Service Component(s) for further processing.

Referring still to FIG. 3, the Service Components 213 may include a Text-to-SQL Service Component 213-1, a Virtual Assistant Service Component 213-2, and an Assisted Operation Service Component 213-3. It is contemplated that the Service Components 213 may also include any other suitable services (e.g., modular services, content generation services, etc.), without departing from the scope of the present disclosure.

The Text-to-SQL Service Component 213-1 may be selected to process the enriched prompt, when the enriched prompt (or the category thereof) is associated with data retrieval. In this regard, the Text-to-SQL Service Component 213-1 may be configured to generate an SQL query based on the enriched prompt and send the SQL query to the Data Storage 215 (or any other suitable data storage systems or database management systems) that contains information requested in the enriched prompt. Accordingly, the Data Storage 215 may execute the SQL query and provide data associated with the requested information to the Text-to-SQL Service Component 213-1. Upon retrieving the data from the Data Storage 215, the Text-to-SQL Service Component 213-1 may convert the retrieved data into a response (in natural language, etc.) and provide the response to the UI Component 212, such that the UI Component 212 may update the UI to present the response to the user via the UE 220.

The Virtual Assistant Service Component 213-2 may be selected to process the enriched prompt, when the enriched prompt (or the category thereof) is associated with general inquiries or requires continuous conversation with the user. In this regard, the Virtual Assistant Service Component 213-1 may be configured to generate a response in natural language and provide the response to the UI Component 212, such that the UI Component may update the UI to present the response in natural language to the user via the UE 220. Specifically, the Virtual Assistant Service Component 213-2 may implement an NLP model (which may be similar or different from the NLP model implemented by the Intent Management Component 211) to generate the response. For instance, the Virtual Assistant Service Component 213-2 may input the enriched prompt (and information associated with the past conversations with the user, in some example implementations) into the NLP model, and the NLP model may process the enriched prompt (e.g., to interpret or extract the meaning of the enriched prompt) and generate an output (e.g., a human-like, natural language response) thereafter. Accordingly, the Virtual Assistant Service Component 213-2 may act as a conversational agent/assistant to handle general inquiries and provide response in natural language, maintaining a coherent and contextually relevant conversation with the user.

The Assisted Operation Service Component 213-3 may be selected to process the enriched prompt, when the enriched prompt (or the category thereof) is associated with an operation that involves or associated with one or more network elements within the Telecommunication Network 230. In this regard, the Assisted Operation Service Component 213-3 may be configured to select, from among the Application Components 214, an Application Component associated with the enriched prompt. Accordingly, the Assisted Operation Service Component 213-3 may instruct the selected Application Component to perform an operation to an associated network element. For instance, the Assisted Operation Service Component 213-3 may generate, based on the enriched prompt, an instruction readable or executable by the selected Application Component to perform or implement the operation. Accordingly, the selected Service Component may provide the generated instruction to the selected Application Component, and the selected Application Component may implement or perform an operation according to the instruction. Example operations that may be implemented or performed by the selected Application Component have been described above with reference to FIG. 2, thus redundant operations associated therewith may be omitted below for conciseness. After the selected Application Component has implemented or performed the operation according to the instruction, the Assisted Operation Service Component 213-3 may receive, from the selected Application Component, a result of the implementation of the operation. Subsequently, the Assisted Operation Service Component 213-3 may provide the result of the implementation of the operation to the UI Component 212, such that the UI Component 212 may update the UI to present the result to the user via the UE 220.

According to example embodiments, the prompt may include multiple intents (e.g., the prompt may include a general inquiry and a data retrieval request, etc.). In this regard, upon determining that the prompt includes multiple intents (at the intent determination stage), the Intent Routing Component 211-1 may generate multiple enriched prompts, each of which is associated with a respective prompt intent. Alternatively, the Intent Routing Component 211-1 may generate a single enriched prompt that reflects the multiple intents and provide the enriched prompt to the Intent Classification Component 211-3. Accordingly, the Intent Classification Component 211-3 may select multiple Service Components (each of which is associated with a respective prompt intent) and provide the enriched prompt to the selected Service Components. Accordingly, the UI Component 212 may receive, from the selected Service Components, multiple responses associated with the prompt. In this regard, the UI Component 212 may update the UI to present the responses in a sequential manner.

As a non-limiting example, assuming that the prompt is “What is a RAN? Can you show me some performance metrics associated therewith?” In this example, the prompt may include a first intent associated with a general inquiry (i.e., to inquire about the meaning of “RAN” in a telecommunication network) and a second intent associated with a data retrieval request (i.e., to retrieve historical performance metrics associated with the RAN).

In this regard, upon determining that the prompt includes multiple intents (at the intent determination stage), the Intent Routing Component 211-1 may generate a first enriched prompt that specifies or supplements the first intent (e.g., “an inquiry for the general information of a Radio Access Network (RAN)”, etc.) and a second enriched prompt that specifies or supplements the second intent (e.g., “a request to retrieve available performance metrics of network elements associated with Radio Access Network X.”, etc.). Accordingly, the Intent Routing Component 211-1 may provide the first and second enriched prompts to the Intent Classification Component 211-3, and the Intent Classification Component 211-3 may select the Virtual Assistant Service Component 213-2 to handle the first enriched prompt and select the Text-to-SQL Service Component 213-1 to handle the second enriched prompt.

Alternatively, the Intent Routing Component 211-1 may generate a single enriched prompt that reflects the both the first and second intents (e.g., “the user is (1) inquiring for the general information of a Radio Access Network (RAN), and (2) requesting the retrieval of available performance metrics of network elements associated with Radio Access Network X”, etc.). Accordingly, the Intent Routing Component 211-1 may provide the enriched prompt to the Intent Classification Component 211-3, and the Intent Classification Component 211-3 may determine that the enriched prompt is associated with a first category (e.g., general inquiry) and a second category (e.g., data retrieval). Accordingly, the Intent Classification Component 211-3 may select the Text-to-SQL Service Component 213-1 and the Virtual Assistance Service Component 213-2 to handle the enriched prompt.

Referring still to FIG. 3, according to example embodiments, the Service Components 213 may communicate and interoperate with each other. For instance, the Virtual Assistant Service Component 213-2 may interoperate with the Text-to-SQL Service Component 213-1 to retrieve (from the Data Storage 215) data required for answering general inquiries, may interoperate with the Assisted Operation Component to schedule a simple operational task (e.g., reboot a network element, etc.), and the like.

Next, an example use case associated with the front-end communication via a UI, according to one or more example embodiments, is described. Specifically, FIG. 4A to FIG. 4D illustrate an example UI configured to engage in a conversation with a user, according to one or more example embodiments. The descriptions of FIG. 4A to FIG. 4D may be provided with reference to the features and operations in FIG. 2 and FIG. 3.

FIG. 4A illustrates an example UI 400, according to one or more example embodiments. The UI 400 in FIG. 4A may be presented to the user (e.g., via the UE 220) when the user first accesses the OSS 210. For instance, after the user has successfully log-in to the OSS 210, the UI component may generate and present the UI 400 to the user (via the UE 220). The UI 400 may be presented to the user in any suitable format, such as a full-size chat window, a chat widget embedded in a portion of a webpage, and the like.

As illustrated in FIG. 4A, the UI 400 may include a Conversation Window 410, a Prompt Input Section 420, and a Send Button 420. The Conversation Window 410 may include a header message 411 (e.g., a welcome message, etc.) and may display the ongoing conversation and the conversation history between the user and the OSS 210 (e.g., the Virtual Assistant Service Component 213-2, etc.). Typically, the user messages (e.g., the prompts) may be displayed on the right of the Conversation Window 410, and the responses from the OSS 210 may be displayed on the left of the Conversation Window 410. The Prompt Input Section 420 may include a text input file that enables the user to input the prompts in text form. The Send Button 420 may, upon being interacted with (e.g., clicked, etc.) by the user, trigger operations to provide the prompt(s) in the Prompt Input Section 420 to the OSS 210 (e.g., Intent Management Component 211, etc.).

It is contemplated that the UI 400 in FIG. 4A to FIG. 4D is simplified for descriptive and illustrative purposes, and the scope of the present disclosure should not be limited thereto. Specifically, the UI 400 may include additional components (e.g., components that allow the user to choose an AI/ML model, provide audio input, upload a file, etc.) and may be configured in a different manner, without departing from the scope of the present disclosure.

FIG. 4B illustrates the UI 400 which reflects the beginning of a conversation between the user and the OSS 210. Specifically, the user has inputted a first prompt 410-1 and the OSS 210 has provided a first response 410-2 to the first prompt 410-1.

As illustrated in FIG. 4B, the first prompt 410-1 includes a general inquiry associated with the capabilities of the OSS 210. In this regard, the user may input the first prompt 410-1 to the Prompt Input Section 420 and interact with the Send Button 420. The first prompt 410-1 may be provided by the UE 220 to the UI Component 212 (via the UI 400), and the UI Component 212 may forward the first prompt 410-1 to the Intent Routing Component 211-1 of the Intent Management Component 211. The Intent Routing Component 211-1 may determine that the intent of the first prompt 410-1 is to inquire about the capabilities of the OSS 210 (e.g., features and services provided by the Service Components 213, etc.), and may then communicate with the Database 211-2 to generate a first enriched prompt based on the first prompt 410-1. Subsequently, the Intent Routing Component 211-1 may provide the first enriched prompt to the Intent Classification Component 211-3. The Intent Classification Component 211-3 may determine that the first enriched prompt is associated with a generic response category and select the Virtual Assistant Service Component 213-2 to handle the first enriched prompt. Accordingly, the Intent Classification Component 211-3 may send the first enriched prompt to the Virtual Assistant Service Component 213-2. The Virtual Assistant Service Component 213-2 may process the first enriched prompt and generate the first response 410-2 thereto. For instance, the Virtual Assistant Service Component 213-2 may communicate with the Text-to-SQL Service Component 213-1 to retrieve (from the Data Storage 215) data of available Service Components in the OSS 210, and then generate the first response 410-2 based thereon. Upon generating the first response 410-2, the Virtual Assistant Service Component 213-2 may provide the first response 410-2 to the UI Component 212, and the UI Component 212 may update the UI 400 to present the first response 410-2 on the Conversation Window 410.

FIG. 4C illustrates the UI 400 that reflects the conversation between the user and the OSS 210, in continuation of the conversation in FIG. 4B. Specifically, after the OSS 210 provided the first response 410-2 to the user (in FIG. 4B), the user has further inputted a second prompt 410-3 and a third prompt 410-5, and the OSS 210 has respectively provided a second response 410-4 and a third response 410-6 thereto. The provisioning of the second prompt 410-3 and third prompt 410-5 may be similar to the provisioning of the first prompt 410-1 (in FIG. 4B), and the provisioning of the second response 410-4 and third response 410-6 may be similar to the provisioning of the first response 410-2 (in FIG. 4B). Thus, redundant descriptions associated therewith may be omitted below for conciseness.

As illustrated in FIG. 4C, the second prompt 410-3 includes an inquiry associated with a specific network metric (i.e., network load) in a specific location (i.e., Region A) for a specific time period (i.e., 24 hours from the time the second prompt 410-3 is inputted). In this regard, upon receiving the second prompt 410-3 and determining the intent thereof, the Intent Routing Component 211-1 may generate a second enriched prompt that supplements the second prompt 410-3 (e.g., specifies the network elements in Region A, specifies the time period for which the data of the network load should be retrieved, etc.). Accordingly, the Intent Classification Component 211-3 may determine that the second enriched prompt is associated with a data retrieval category and select the Text-to-SQL Service Component 213-1 to handle the second enriched prompt. After receiving the second enriched prompt from the Intent Classification Component 211-3, the Text-to-SQL Service Component 213-1 may retrieve the associated data from the Data Storage 215, convert the data in a readable format (e.g., in natural language, etc.), and provide the converted data to the UI Component 212 for presentation. Alternatively or additionally, upon retrieving the associated data, the Text-to-SQL Service Component 213-1 may provide the data to the Virtual Assistant Service Component 213-2, and the Virtual Assistant Service Component 213-2 may generate a response (in natural language) and provide the response to the UI Component 212 for presentation. Upon receiving the response/data from the Text-to-SQL Service Component 213-1 or the Virtual Assistant Service Component 213-2, the UI Component 212 may update the UI 400 to present the second response 410-4 on the Conversation Window 410.

Referring still to FIG. 4C, the third prompt 410-5 includes several inquiries associated with the second response 410-4. Specifically, the third prompt 410-5 includes two intents, i.e., a request for clarifying a portion of the second response 410-4 and a request for a guidance to optimize the network performance based on the second response 410-4. In this regard, upon receiving the third prompt 410-5 and determining the intents thereof, the Intent Routing Component 211-1 may generate two enriched prompts (e.g., a third enriched prompt and a fourth enriched prompt), each of which is associated with a respective intent of the third prompt 410-5. Alternatively, the Intent Routing Component 211-1 may generate an enriched prompt (e.g., a third enriched prompt) that specifies or supplements the two intents. Accordingly, the Intent Classification Component 211-3 may select the Virtual Assistant Service Component 213-2 to handle the enriched prompt(s). The Virtual Assistant Service Component 213-2 may generate one or more responses based on the enriched prompt(s) and provide the one or more generated responses to the UI Component 212. Subsequently, the UI Component may update the UI 400 to present the third response 410-6 on the Conversation Window 410.

FIG. 4D illustrates the UI 400 that reflects the conversation between the user and the OSS 210, in continuation of the conversation in FIG. 4C. Specifically, after the OSS 210 provided the third response 410-6 to the user (in FIG. 4C), the user has further inputted a fourth prompt 410-7, and the OSS 210 has provided a fourth response 410-8 and a fifth response 410-9 thereto. The provisioning of the fourth prompt 410-7 may be similar to the provisioning of the first prompt 410-1 (in FIG. 4B), and the provisioning of the fourth response 410-8 and fifth response 410-9 may be similar to the provisioning of the first response 410-2 (in FIG. 4B) and the provisioning of the second response 410-4 and third response 410-6 (in FIG. 4C). Thus, redundant descriptions associated therewith may be omitted below for conciseness.

As illustrated in FIG. 4D, the fourth prompt 410-7 includes a request to perform an operation to manage one or more network elements, as suggested in the third response 410-6 provided by the OSS 210 (in FIG. 4C). In this regard, upon receiving the fourth prompt 410-7 and determining the intent thereof, the Intent Routing Component 211-1 may generate an enriched prompt that supplements the fourth prompt 410-6 (e.g., specifies the parameters for adjusting the DRX configuration, specifies the timing for which the DRX configuration should be adjusted, specifies that the adjustment is applicable to the available network elements in Region A, etc.). Accordingly, the Intent Classification Component 211-3 may determine that the enriched prompt is associated with an operational instruction category and select the Assisted Operation Service Component 213-3 to handle the enriched prompt. In addition, the Intent Classification Component 211-3 may also send the enriched prompt to the Virtual Assistant Service Component 213-2, such that the Virtual Assistant Service Component 213-2 may generate a response to the fourth prompt 410-7 to notify the user that the requested operation is in progress. Subsequently, the Virtual Assistant Service Component 213-2 may provide the response to the UI Component 212, and the UI Component 212 may update the UI 400 to present the fourth response 410-8 on the Conversation Window 410.

On the other hand, after receiving the enriched prompt from the Intent Classification Component 211-3, the Assisted Operation Service Component 213-3 may select one or more of the Application Components 214 and instruct the selected Application Component(s) to perform the associated operation(s) to adjust the DRX configuration of the associated network element(s). Subsequently, the Assisted Operation Service Component 213-3 may receive, from the selected Application Component(s), a result of the implementation of the operation. For instance, assuming that the Assisted Operation Service Component 213-3 has selected two Application Components 214 (each of which is configured to adjust the DRX configuration of a respective network element), the Assisted Operation Service Component 213-1 may receive two results from the two selected Application Components 214. Alternatively, one or more of the selected Application Components 214 may store the associated result in the Data Storage 215, and the Assisted Operation Service Component 213-3 may retrieve the result(s) from the Data Storage 215. Upon receiving the result(s), the Assisted Operation Service Component 213-3 may generate a response based on the received result(s) and provide the generated response to the UI Component 212. Alternatively, the Assisted Operation Service Component 213-3 may provide the received result(s) to the Virtual Assistant Service Component 213-2, and the Virtual Assistant Service Component 213-2 may generate a response in natural language based on the received result(s) and provide the response to the UI Component 212. Upon receiving the response from the Assisted Operation Service Component 213-1 or the Virtual Assistant Service Component 213-2, the UI Component 212 may update the UI 400 to present the fifth response 410-9 on the Conversation Window 410.

It is contemplated that the above-described features of FIG. 3 and FIG. 4A to FIG. 4D are merely examples, and the scope of the present disclosure should not be limited thereto. Specifically, the example use case in FIG. 3 is merely an example to illustrate a potential implementation of the OSS 210 (particularly, to illustrate example sub-components of the Intent Management Component 211 and example services that may be provided and managed by the Service Components 213), while the example use case in FIG. 4A to FIG. 4D is merely an example to illustrate how the example embodiments enable a user to perform various tasks by interacting with a single UI. It can be understood that any suitable variation may be applicable, without departing from the scope of the present disclosure.

### Example Methods and Operations

As described above, the components of the OSS of example embodiments (e.g., UI Component, Intent Management Component, Service Components, Application Components, Data Storage, etc.) may be configured to interoperate with each other and perform one or more methods/operations to enable a user to effectively and efficiently manage one or more network operations in a telecommunication network. In the following, descriptions of several example methods and the associated operations are provided.

One or more operations (or the data involved therein) may be similar to those described above with reference to FIG. 2 to FIG. 4D, thus it may be understood that the described operation(s) and data may be similarly applied to the operations described herein (unless described otherwise) and redundant descriptions associated therewith may be omitted for conciseness.

For descriptive purposes, the methods and operations may be mainly described as being performed by one or more specific components, although it can be understood that, in actual implementations, another related component(s) may perform similar/related operations, without departing from the scope of the present disclosure. For instance, an operation of the UI Component receiving a prompt from a UE may indicate or suggest an operation of the UE sending the prompt to the UI Component, a description of the Service Component providing an instruction readable and executable by an Application Component may indicate or suggest an operation of the Application Component reading and executing the instruction, and the like.

According to example embodiments, one or more components of the OSS may be implemented in one or more devices or hardware components, and one or more operations described hereinbelow may be performed by the one or more devices/hardware components. For instance, the Intent Management Component may be implemented in a device that includes a processor and a memory storage (or any other suitable storage mediums), wherein the memory storage may include computer-executable instructions which, when being executed by the processor, cause the processor to perform one or more operations of the Intent Management Component.

In this regard, multiple operations described herein (e.g., operations associated with the Intent Management Component, the UI Component, the Service Component, the Application Component, etc.) may be performed or implemented by the same device or hardware component. Additionally or alternatively, multiple operations described herein may be performed or implemented by different devices or hardware components of a system (e.g., a first device may perform and implement the operations associated with the Intent Management Component, a second device may perform and implement the operations associated with the Service Component, a third device may perform and implement the operations associated with the UI Component, a fourth device may perform and implement the operations associated with the Application Component, etc.).

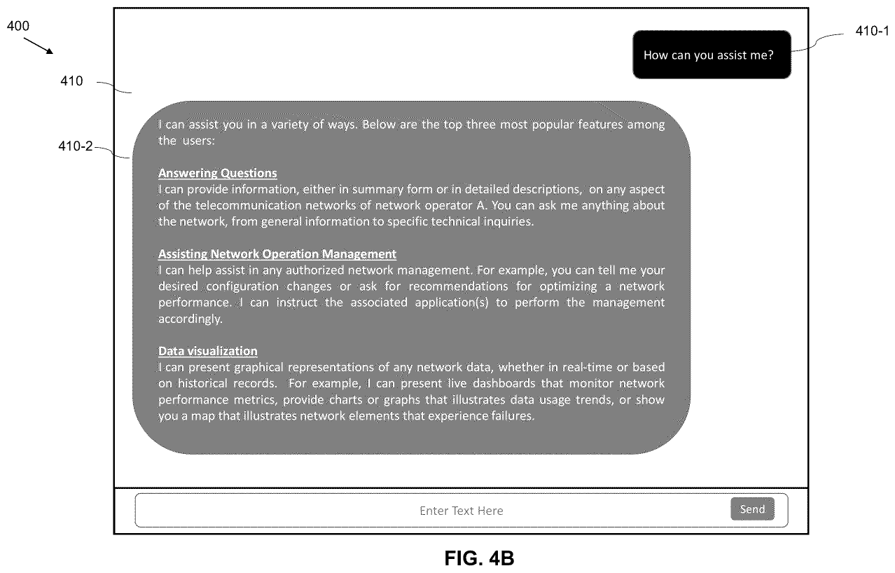

FIG. 5 illustrates a block diagram of an example method 500 for processing a prompt, according to one or more example embodiments. The operations in method 500 may be performed or implemented by an Intent Management Component (e.g., Component 211 in FIG. 2 and FIG. 3) or a device that implements the Intent Management Component.

As illustrated in FIG. 5, at operation S501, the device (that implements the Intent Management Component) may be configured to receive a prompt associated with a telecommunication network. For instance, the device may present a UI to a UE, and then receive the prompt from the UE via the UI. According to example embodiments where the Intent Management Component and UI Component that manages the UI (e.g., Component 212 in FIG. 2 and FIG. 3) are implemented in different devices, the device that implements the Intent Management Component may receive the prompt from the device that implements the UI Component.

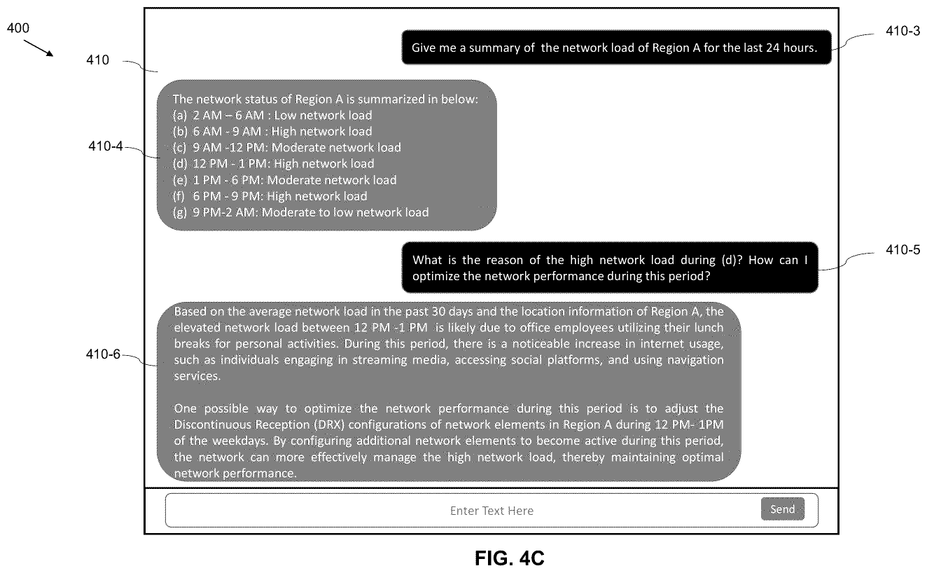

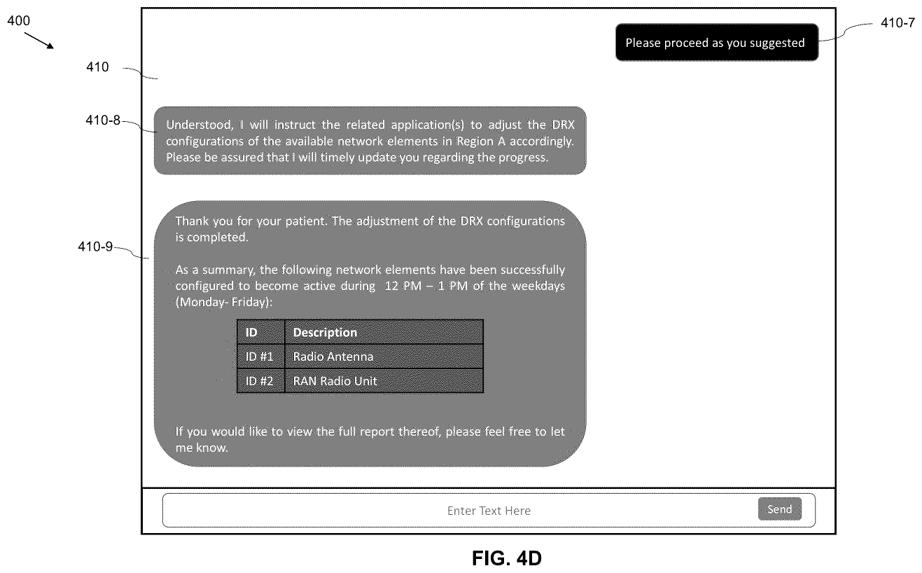

At operation S502, the device may be configured to determine an intent of the prompt via at least one NLP operation. Example operations associated therewith are described below with reference to FIG. 6. At operation S503, the device may be configured to generate an enriched prompt via at least one RAG operation, wherein the enriched prompt may include information associated with the determined intent. Example operations associated therewith are described below with reference to FIG. 7.

At operation S504, the device may be configured to determine a category of the enriched prompt. For instance, the device may determine the category of the enriched prompt based on at least one of: a set of predefined mappings and an NLP operation. At operation S505, the device may be configured to select, from among a plurality of services, a service associated with the determined category. Subsequently, at operation S506, the device may be configured to provide the selected service based on the enriched prompt. According to example embodiments where the Intent Management Component and Service Components (e.g., Components 213 in FIG. 2 and FIG. 3) that manage the services are implemented in different devices, the device that implements the Intent Management Component may select, from among a plurality of Service Components (or a plurality of devices that implement the plurality of Service Components), a Service Component (or a device that implements the Service Component) that manages the service that is associated with the determined category, and then provide the enriched prompt thereto.

FIG. 6 illustrates a block diagram of an example method 600 for determining the intent of a prompt, according to one or more example embodiments. The operations of method 600 may be part of operation S502 in method 500 and may be performed by the same device that performs the operation S502 in method 500. Specifically, similar to the operations in method 500, the operations in method 600 may be performed or implemented by the Intent Management Component (e.g., Component 211 in FIG. 2 and FIG. 3) or the device that implements the Intent Management Component. In some example implementations, the Intent Management Component may include an Intent Routing Component (e.g., Component 211-1 in FIG. 3), and the operations of method 600 may be implemented by the Intent Routing Component (or a device that implements the Intent Routing Component).

Referring to FIG. 6, at operation S601, the device (that implements the Intent Management Component and, in some cases, the Intent Routing Component) may be configured to input the prompt (received at operation S501, etc.) into an NLP model. At operation S602, the device may be configured to obtain, from the NLP model, an intent classification of the prompt. At operation S603, the device may be configured to determine, based on the intent classification, the intent of the prompt.

FIG. 7 illustrates a block diagram of an example method 700 for generating an enriched prompt, according to one or more example embodiments. The operations of method 700 may be part of operation S503 in method 500 and may be performed by the same device that performs the operation S503 in method 500. Specifically, similar to the operations in method 500, the operations in method 700 may be performed or implemented by the Intent Management Component (e.g., Component 211 in FIG. 2 and FIG. 3) or the device that implements the Intent Management Component. In some example implementations, the Intent Management Component may include the Intent Routing Component (e.g., Component 211-1 in FIG. 3), and the operations of method 700 may be implemented by the Intent Routing Component (or a device that implements the Intent Routing Component).

Referring to FIG. 7, at operation S701, the device (that implements the Intent Management Component and, in some cases, the Intent Routing Component) may be configured to access a database (e.g., Database 211-2 in FIG. 3) that stores data associated with the telecommunication network. At operation S702, the device may be configured to retrieve, from the database, data associated with the intent of the prompt (determined at operation S502). At operation S703, the device may be configured to integrate the retrieved data with the prompt to obtain the enriched prompt.

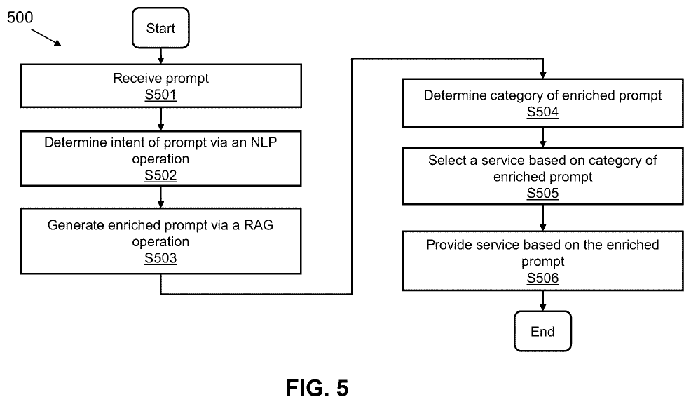

FIG. 8 illustrates a block diagram of an example method 800 for engaging with a UE, according to one or more example embodiments. The operations of method 800 may be performed or implemented by a UI Component (e.g., Component 212 in FIG. 2 and FIG. 3) or a device that implements the UI Component. According to example embodiments, the operations of method 800 may be performed or implemented by the same device that implements the Intent Management Component and performs the operations of any of the method 500 to method 700. In this case, the Intent Management Component and the UI Component may both be implemented in the same device. Alternatively, the operations of method 800 may be performed or implemented by a device different than the device that implements the Intent Management Component. In this case, the Intent Management Component and the UI Component may be implemented in different devices.

Referring to FIG. 8, at operation S801, the device (that implements the UI Component) may be configured to present a UI (e.g., UI 400, etc.) to a UE (e.g., UE 220 in FIG. 2 and FIG. 3). At operation S802, the device may be configured to receive a prompt from the UE and via the UI. In this regard, if the device also implements the Intent Management Component, the device may perform operations to process the received prompt (e.g., by performing one or more operations of one or more of method 500 to method 700). Alternatively, if the Intent Management Component is implemented in another device, the device (which performs the operations of method 700) may provide the received prompt to said another device for further processing. Accordingly, at operation S803, the device may be configured to receive, from a service (e.g., a service selected at operation S505, a device that manages the selected service, etc.), a response associated with the prompt. At operation S804, the device may be configured to update the UI to present the response. The response may be presented in natural language and may include information (e.g., answer, result, etc.) that responds to the user prompt.

In addition to the example methods and operations associated with the implementations of the Intent Management Component and the UI Component as described above, example embodiments of the present disclosure also provide methods and operations associated with the implementations of one or more Service Components (e.g., Components 213 in FIG. 2 and FIG. 3). Specifically, a device that implements the Intent Management Component and/or the UI Component may also implement one or more Service Components to provide or manage one or more services. Alternatively, the one or more Service Components may be implemented in a different device. In this case, the device that implements the Intent Management Component may provide an enriched prompt to the device that implements the Service Component(s), such that the device that implements the Service Component(s) may utilize the enriched prompt to provide a service(s).

As described above with reference to FIG. 3 and FIG. 4A to FIG. 4D, the Service Component may include a Service Component that provides a Text-to-SQL service, a Service Component that provides a virtual assistant service, and a Service Component that provides an assisted operation service. In the following, example methods and operations associated with each of these Service Components are described.

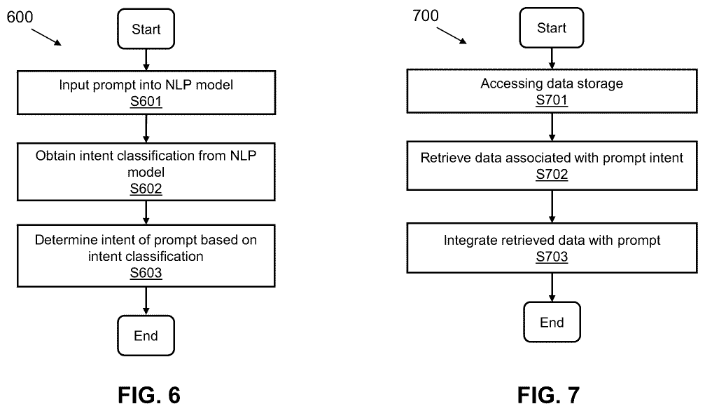

FIG. 9 illustrates a block diagram of an example method 900 for providing a Text-to-SQL service, according to one or more example embodiments. The operations of method 900 may be performed or implemented by a Text-to-SQL Service Component (e.g., Text-to-SQL Service Component 213-1 in FIG. 3) or a device that implements the Text-to-SQL Service Component.

Further, the operations of method 900 may be performed subsequent to operation S506 of method 500. Specifically, the device that implements or performs method 500 may determine that the category of the enriched prompt includes a data retrieval category (at operation S504), and may thus select the Text-to-SQL service (at operation S505) and provide the Text-to-SQL service based on the enriched prompt (at operation S506). According to example embodiments where the Intent Management Component and the Text-to-SQL Service Component are implemented in different devices, the device that implements the Intent Management Component may select the device that implements the Text-to-SQL Service Component (at operation S505) and provide the enriched prompt thereto, such that said device may utilize the enriched prompt to provide the Text-to-SQL service (at operation S506).

Referring to FIG. 9, at operation 901, the device (that implements the Text-to-SQL Service Component) may be configured to generate an SQL query based on the enriched prompt. At operation S902, the device may be configured to send the SQL query to a data storage (e.g., Data Storage 215 in FIG. 2 and FIG. 3) to retrieve data associated with the enriched prompt. At operation S903, the device may be configured to update the UI (presented to the UE at operation S801) to present the retrieved data. According to example embodiments where the Text-to-SQL Service Component and the UI Component are implemented in different devices, the device that implements the Text-to-SQL Service Component may obtain a response based on the retrieved data (e.g., communicate with the Virtual Assistance Service Component or the associated device to obtain the response that presents the retrieved data in natural language or a specific format, etc.) and then provide the response to the device that implements the UI Component. Accordingly, the device that implements the UI Component may update the UI to present the response thereon.

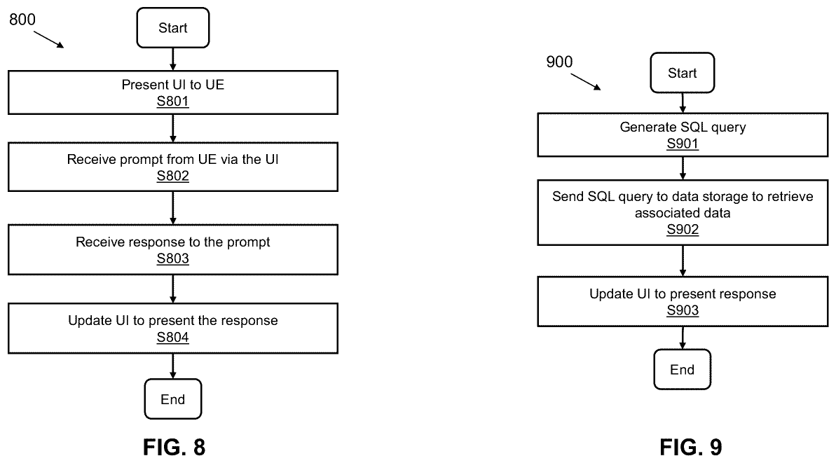

FIG. 10 illustrates a block diagram of an example method 1000 for providing a virtual assistant service, according to one or more example embodiments. The operations of method 1000 may be performed or implemented by a Virtual Assistant Service Component (e.g., Virtual Assistant Service Component 213-2 in FIG. 3) or a device that implements the Virtual Assistant Service Component.

Similar to method 900, the operations of method 1000 may be performed subsequent to operation S506 of method 500. Specifically, the device that implements the Intent Management Component may determine that the category of the enriched prompt includes a generic response category (at operation S504), and may thus select the virtual assistant service (at operation S505) and provide the virtual assistance service based on the enriched prompt (at operation S506). According to example embodiments where the Intent Management Component and the Virtual Assistance Service Component are implemented in different devices, the device that implements the Intent Management Component may select the device that implements the Virtual Assistance Service Component (at operation S505) and provide the enriched prompt thereto, such that said device may utilize the enriched prompt to provide the virtual assistance service (at operation S506).

Referring to FIG. 10, at operation S1001, the device (that implements the Virtual Assistance Service Component) may be configured to generate a response based on the enriched prompt and an NLP model. The response may be presented in natural language. At operation S1002, the device may be configured to update the UI (presented to the UE at operation S801) to present the response in natural language. According to example embodiments where the Virtual Assistance Service Component and the UI Component are implemented in different devices, the device that implements the Virtual Assistance Service Component may provide the response to the device that implements the UI Component. Accordingly, the device that implements the UI Component may update the UI to present the response thereon.

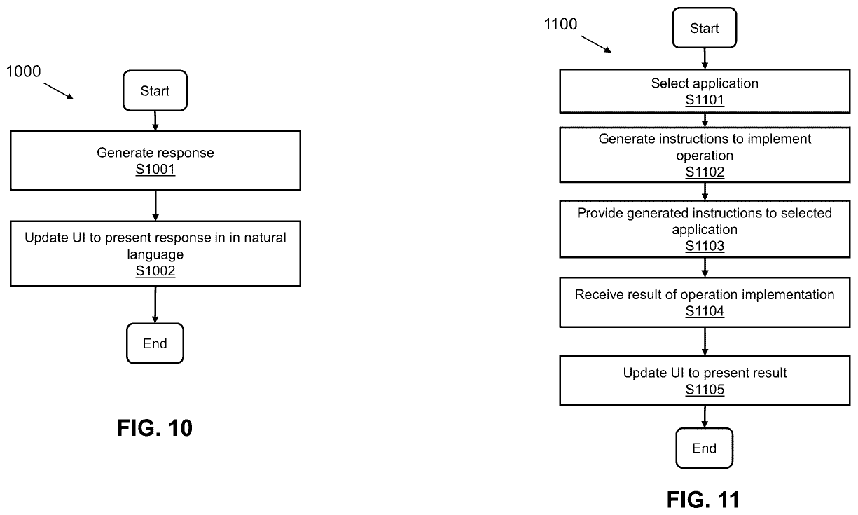

FIG. 11 illustrates a block diagram of an example method 1100 for providing an assisted operation service, according to one or more example embodiments. The operations of method 1100 may be performed or implemented by an Assisted Operation Service Component (e.g., Assisted Operation Service Component 213-3 in FIG. 3) or a device that implements the Assisted Operation Service Component.

Similar to method 900 and method 1000, the operations of method 1100 may be performed subsequent to operation S506 of method 500. Specifically, the device that implements the Intent Management Component may determine that the category of the enriched prompt may include an operational instruction category (at operation S504), and may thus the device select the assisted operation service (at operation S505) and provide the assisted operation service based on the enriched prompt (at operation S506). According to example embodiments where the Intent Management Component and the Assisted Operation Service Component are implemented in different devices, the device that implements the Intent Management Component may select the device that implements the Assisted Operation Service Component (at operation S505) and provide the enriched prompt thereto, such that said device may utilize the enriched prompt to provide the assisted operation service (at operation S506).

Referring to FIG. 11, at operation S1101, the device (that implements the Assisted Operation Service Component) may be configured to select, from among a plurality of applications (e.g., applications that are managed by Application Components 214 in FIG. 2 and FIG. 3), an application associated with the enriched prompt. At operation S1102, the device may be configured to generate, based on the enriched prompt, an instruction readable by the selected application to perform or implement an operation on a network element in the telecommunication network. At operation S1103, the device may be configured to provide, to the selected application, the generated instruction. According to example embodiments where the Assisted Operation Service Component and the Application Component that manages the selected application are implemented in different devices, the device that implements the Assisted Operation Service Component may select the device that implements the Application Component that manages the selected application (at operation S1101) and provide the generated instruction thereto (at operation S1103), such that said device may utilize the generated instruction to execute or implement the selected application.

Referring still to FIG. 11, at operation S1104, the device may be configured to receive, from the selected application (or a device associated therewith, if applicable), a result of the implementation of the operation. According to example embodiments where the Assisted Operation Service Component and Application Component that manages the selected application are implemented in different devices, the device that implements the Assisted Operation Service Component may receive the result from the device that implements said Application Component.

At operation S1105, the device may be configured to update the UI (presented to the UE at operation S801) to present the response. According to example embodiments where the Assisted Operation Service Component and UI Component that manages the UI are implemented in different devices, the device that implements the Assisted Operation Service Component may obtain a response based on the received result (e.g., communicate with the Virtual Assistance Service Component or the associated device to obtain the response that presents the result in natural language, etc.) and then provide the response to the device that implements the UI Component. Accordingly, the device that implements the UI Component may update the UI to present the response thereon.

According to example embodiments, one or more operations in FIG. 5 to FIG. 11 may be collectively implemented or performed by a system (e.g., OSS 210 or one or more devices configured to implement the OSS 210, etc.) or one or more devices that implement the associated component(s). Further, one or more operations in FIG. 5 to FIG. 11 may be performed by the same device or different devices. Further, multiple operations may be performed in any suitable sequential manner. For instance, multiple services may be selected by the Intent Management Component to simultaneously provide multiple services. In this regard, multiple operations for performing multiple services may be performed simultaneously, and the like.

In view of the above, example embodiments of the present disclosure provide methods and operations performable or implementable by one or more components, devices, systems, and the like, thereby enabling a user to effectively and efficiently manage one or more network operations.

Specifically, the method and operations in FIG. 5 may be automatically implemented by a device that implements the Intent Management Component when the device receives a prompt (provided by a user), thereby processing the prompt to determine an intent of the prompt, enrich the prompt, select appropriate service, without requiring manual intervention from the user.

The method and operation in FIG. 6 may be automatically implemented during the intent determination stage, leveraging the capabilities of the NLP model (e.g., capabilities to accurately interpret diverse types of user prompts, extract key information from a prompt, etc.) to accurately determine the intent of the prompt provided by the user. The method and operations in FIG. 7 may be automatically implemented during the prompt enrichment stage, leveraging the capabilities of the RAG process (e.g., capabilities to retrieve up-to-date data and seamlessly integrate relevant data into the original prompt) to generate an enriched prompt that more accurately reflects the users' intent and ultimately increase the accuracy of the network management operations.

The methods and operations in FIG. 5, FIG. 6, and FIG. 7 are particularly useful in handling different types of prompts, especially when the prompts are ambiguous or overly generic. By leveraging AI/ML techniques like NLP and RAG, example embodiments can interpret imprecise/unclear prompts, enrich them with relevant contextual data, and transform them into clear, actionable instructions. This approach ensures that even generalized queries are accurately mapped to specific network management tasks, thereby enhancing operational efficiency and reducing the likelihood of misinterpretation.

The method and operations in FIG. 8 may be automatically implemented to when the users access the system (e.g., OSS) to manage one or more network operations. In this regard, the method and operations in FIG. 8 enable the users to interact with a single UI in an intuitive, conversational manner, thereby simplifying the network operation management and allowing users of different backgrounds (e.g., new/inexperienced users, experienced users, etc.) simply interact with the UI to effectively manage various network operations.

The method and operations in FIG. 9 to FIG. 11 may be automatically implemented when a respective service (or the associated Service Component) is selected. These methods and operations exemplify the integration of various types of modular services within the system (e.g., OSS), which enhances the scalability and flexibility of the system (since various types of services may be added, adjusted, and implemented in the system according to the specific requirement, etc.).

It is contemplated that, the methods, operations, advantages, and significances described above with reference to FIG. 5 to FIG. 11 are merely examples and the scope of the present disclosure should not be limited thereto. Specifically, one or more operations in FIG. 5 to FIG. 11 may be performed differently, less or additional operations may be involved, additional advantages may be achieved, and the like, without departing from the scope of the present disclosure.

### Example Device

One or more components of the example embodiments (e.g., OSS, UI Component, Intent Management Component, Service Component, Application Component, etc.), as well as the operations associated therewith, may be implemented in one or more devices or hardware components.

In the following, descriptions of an example device (in which one or more example embodiments may be implemented) are provided. It is contemplated that one or more features, operations, and methods described above may be implemented or performed by the device. For instance, the one or more operations or methods may be performed by at least one processor of the device upon executing machine-readable instructions or computer-readable instructions stored in a memory or a storage component of the device.

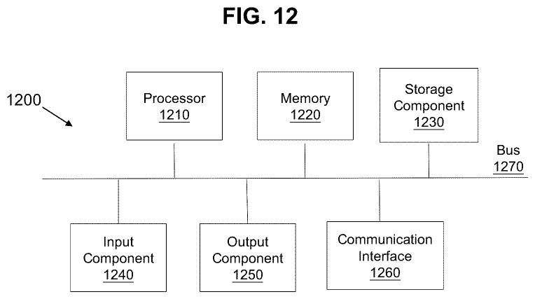

FIG. 12 illustrates a block diagram of an example device 1200 for implementing one or more example embodiments. As shown in FIG. 12, the device 1200 includes a processor 1210, a memory 1220, a storage component 1230, an input component 1240, an output component 1250, a communication interface 1260, and a bus 1270.

The processor 1210, as used herein, means any type of computational circuit that may comprise hardware elements and software elements. The processor 1210 may be embodied as a multi-core processor, a single core processor, or a combination of one or more multi-core processors and/or one or more single core processors, a distributed processing system, or the like. The processor 1210 may be a Central Processing Unit (CPU), a graphics processing unit (GPU), an accelerated processing unit (APU), an application-specific integrated circuit (ASIC), or another type of processing component.

Memory 1220 includes a non-transitory computer readable medium. Memory 1220 includes a random-access memory (RAM), a read only memory (ROM), and/or another type of dynamic or static storage device (e.g., a flash memory, a magnetic memory, and/or an optical memory) that stores information and/or instructions for use by processor 1210. The memory 1220 comprises machine-readable instructions which are executable by the processor 1210. These machine-readable instructions when executed by the processor 1210 cause the processor 1210 to perform one or more method steps of an embodiment described above.

Storage component 1230 stores information and/or software related to the operation and use of the device 1200. For example, storage component 1230 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 1240 is configured to receive information, such as user input. For example, the input component 1240 may include, but not be limited to, a touch screen display, a keyboard, a keypad, a mouse, a button, a switch, and/or a microphone. Additionally, or alternatively, the input component 1240 may include a sensor for sensing information (e.g., a global positioning system (GPS), an accelerometer, a gyroscope, and/or an actuator).

Output component 1250 is configured to provide output information from the device 1200. For example, the output component 1250 may be, but not limited to, a display, a speaker, an instruction device to an external device, and/or one or more light-emitting diodes (LEDs).

Communication interface 1260 is an interface that provides a communication connection to other devices, such as external devices and internal devices. The connection by the communication interface 1260 can be a wired connection, a wireless connection, or a combination of wired and wireless connections, and can be a direct connection or an indirect connection via a communication network that exists between the device 400 and other devices. In other words, the standard of the communication interface 1260 is not limited.

The bus 1270 acts as an interconnect between the processor 1210, the memory 1220, the storage component 1230, the input component 1240, the output component 1250, and the communication interface 1260 of the device 1200. The bus 1270 may include a wired interconnection or a wireless interconnection.

The number and arrangement of components shown in FIG. 12 are provided as an example. In practice, device 1200 may include additional components, fewer components, different components, or differently arranged components than those shown in FIG. 12. Additionally, or alternatively, a set of components (e.g., one or more components) of device 1200 may perform one or more functions described as being performed by another set of components of device 1200. Further, one or more method steps described in any of the embodiments may be performed utilizing a plurality of devices 1200 in communication with one another.

### Example Implementation Environment

Example embodiments of the present disclosure may be implemented in any suitable type of environment. In the following, an example environment (in which the example embodiments may be implemented) is described.

FIG. 13 illustrates a block diagram of an example environment 1300 for implementing in which systems or methods, described herein, may be implemented. The implementation environment 1300 includes a UE (User equipment) 1310, a service environment 1320, and a network 1330. The service environment 1320 include one or more sub-environments 1321. To illustrate this, FIG. 13 shows, for convenience, examples of a 1st sub-environment 1321-1, a 2nd sub-environment 1321-2, and an N-th sub-environment 1321-N (where N is any natural number).

The UE 1310 is connected to the network 1330, and the network 1330 is connected to the service environment 1320. The connections may be wired, wireless, or a combination of both wired and wireless. The UE 1310 and the service environment 1320 are connected via the network 1330.

The UE 1310 is a device that communicates with the service environment 1320. The UE 1310 receives information from the service environment 1320 and/or sends information to the service environment 1320. Also, the UE 1310 may generate and/or store information to be transmitted, as necessary. Also, the UE 1310 may store and/or process information that is received, as necessary.

The example FIG. 13 refers to the “UE”. However, it should be understood by those skilled in the art that general terms such as “user device,” “terminal,” “terminal device,” “communication device,” and “communication terminal” can be used interchangeably with the term “UE.”

For example, the UE 1310 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 1320 is an environment that communicates with the UE 1310 to provide one or more services. The service environment 1320 receives information from the UE 1310 and/or sends information to the UE 1310. Also, the service environment 1320 may generate and/or store information to be transmitted, as necessary. Also, the service environment 1320 may store and/or process information that is received, as necessary. For example, the service environment 1320 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 13 refers to the “service environment”. The term “service environment” is used to refer to the broader context within which services operate. For example, cloud environments, platforms, computing systems, network systems, and cloud systems generally represent the environments in which services are conducted, and these are included within the “service environment.” However, the “service environment” is not limited to these examples. Additionally, the specific types of environments within the “service environment” are not restricted. For instance, cloud environments and cloud systems can be categorized as private cloud, public cloud, hybrid cloud, or multi-cloud, all of which are included within the “service environment.”

The one or more services provided by the service environment 1320 is not specifically limited and can be adjusted according to the embodiments. For example, the services may include a service that provides information to the UE 1310, a service that stores information from the UE 1310, or a service that performs processing based on information from the UE 1310 and returns the results of the processing.

In an embodiment, the Service Environments 1320 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as “Virtual” or “Virtualized” to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 1320 includes one or more devices, such as servers and network devices, which provide services or perform processes. The placement of these devices within the service environment 1320 can be determined as appropriate. Additionally, if the service environment 1320 includes one or more sub-environments 1321, the placement of devices can be determined based on predetermined policies for each sub-environment 1321. For example, devices related to the first service may be placed in the 1st sub-environment 1321-1, and devices related to the second service may be placed in the 2nd sub-environment 1321-2. In another example, devices expected to have a higher load than a predetermined threshold may be placed in the 1st sub-environment 1321-1, while devices expected to have a lower load than the predetermined threshold may be placed in the 2nd sub-environment 1321-2. In this way, specific devices can be placed in specific sub-environments 1321. Conversely, each sub-environment 1321 can be specialized for a particular purpose.

In an embodiment, all processes executed in a single service may run within a single service environment, or in multiple service environments. Multiple processes executed in a single service could be provided by different service environments.

The network 1330 is a network that exchanges information between the UE 1310 and the service environment 1320. The network 1330 includes one or more wired and/or wireless networks.

For example, the network 1330 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 1330 can be a part of a network. For example, in a 5G network that includes a RAN, a transport network, and a core network, the network 1330 can be at least one of the RAN, the transport network, or the core network. For example, the service environment 1320 could be in the core network, in which case the network 1330 could correspond to a network that is a combination of a RAN and a transport network and is part of the 5G network.

According to example embodiments, the OSS 210 (in FIG. 2 and FIG. 3), as well as one or more components therein, may be implemented in the service environment 1320. As a non-limiting example, the components of the OSS 210 may be implemented in different sub-environments (e.g., UI Component 212 may be implemented in the 1st sub-environment 1321-1, Intent Management Component 211 may be implemented in the 2nd sub-environment 1321-2, etc.). The UE 1310 may be similar to the UE 220 (in FIG. 2 and FIG. 3) and may be utilized by a user to access the service environment 1320 and utilize the OSS 210 to manage one or more network operations in the network 1330 (or another network that communicatively coupled to the service environment 1320).

The number and arrangement of devices and networks shown in FIG. 13 are provided as an example. It should be understood that any changes that may be implemented by those skilled in the art, such as the addition or rearrangement of well-known devices or networks at the time of implementation, are included in this disclosure.

### Various Aspects of Embodiments

It is contemplated that the example embodiments described hereinabove are merely examples of possible embodiments of the present disclosure, and are not intended to limit or restrict the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations. Further, it can be understood that the advantages and significances described with reference to the systems and devices may be similarly applicable to the methods and operations, and vice versa.

Some embodiments may relate to a device, a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that devices, systems, and/or methods, described herein, may be implemented in different forms of hardware, firmware, or a combination of hardware and software. The actual specialized control hardware or software code used to implement these devices, systems, and/or methods is not limited to the implementations. Thus, the operation and behavior of the devices, systems, and/or methods were described herein without reference to specific software code—it is understood that software and hardware may be designed to implement the devices, systems, and/or methods based on the description herein.

In view of the above, various further respective aspects and features of embodiments of the present disclosure may be defined by the following items:
Item [1]: A device configured to: receive a prompt associated with a telecommunication network; determine, via a Natural Language Processing (NLP) operation, an intent of the prompt; generate, via a Retrieval-Augmented Generation (RAG) operation, an enriched prompt that may include information associated with the determined intent; determine a category of the enriched prompt; select, from among a plurality of services, a service associated with the determined category; and provide the selected service based on the enriched prompt.
Item [2]: The device according to item [1], wherein the NLP operation may include: inputting the prompt into an NLP model; obtaining, from the NLP model, an intent classification of the prompt; and determining, based on the intent classification, the intent of the prompt.

Item [3]: The device according one or more of items [1]-[2], wherein the RAG operation may include: accessing a database that stores data associated with the telecommunication network; retrieving, from the database, data associated with the determined intent of the prompt; and integrating the retrieved data with the prompt to obtain the enriched prompt.
Item [4]: The device according one or more of items [1]-[3], wherein the device may be further configured to: present, to a user equipment (UE), a UI; receive, from the UE and via the UI, the prompt; receive, from the selected Service Component, a response associated with the prompt; and update the UI to present the response.
Item [5]: The device according to item [4], wherein the category of the enriched prompt may include a data retrieval category, and wherein the device may be configured to provide the service by: generating, based on the enriched prompt, an SQL query; sending, to a data storage, the SQL query to retrieve data associated with the enriched prompt; and updating the UI to present the retrieved data.
Item [6]: The device according to one or more of items [4]-[5], wherein the category of the enriched prompt may include a generic response category, and wherein the device may be configured to provide the service by: generating a response based on the enriched prompt and an NLP model; and updating the UI to present the response in natural language.
Item [7]: The device according to one or more of items [4]-[6], wherein the category of the enriched prompt may include an operational instruction category, and wherein the device may be configured to provide the service by: selecting, from among a plurality of applications, an application associated with the enriched prompt; generating, based on the enriched prompt, an instruction executable by the selected application to implement an operation on a network element in the telecommunication network; providing, to the selected application, the generated instruction; receiving, from the selected application, a result of implementation of the operation; updating the UI to present the result of the implementation of the operation.
Item [8]: A method that may include: receiving a prompt associated with a telecommunication network; determining, via a Natural Language Processing (NLP) operation, an intent of the prompt; generating, via a Retrieval-Augmented Generation (RAG) operation, an enriched prompt that may include information associated with the determined intent; determining a category of the enriched prompt; selecting, from among a plurality of services, a service associated with the determined category; and providing the selected service based on the enriched prompt.
Item [9]: The method according to item [8], wherein the NLP operation may include: inputting the prompt into an NLP model; obtaining, from the NLP model, an intent classification of the prompt; and determining, based on the intent classification, the intent of the prompt.
Item [10]: The method according one or more of items [8]-[9], wherein the RAG operation may include: accessing a database that stores data associated with the telecommunication network; retrieving, from the database, data associated with the determined intent of the prompt; and integrating the retrieved data with the prompt to obtain the enriched prompt.
Item [11]: The method according one or more of items [8]-[10], further comprising: presenting, to a user equipment (UE), a user interface (UI); receiving, from the UE and via the UI, the prompt; receiving, from the selected service, a response associated with the prompt; and updating the UI to present the response.
Item [12]: The method according to item [11], wherein the category of the enriched prompt may include a data retrieval category, and wherein the providing the service may include: generating, based on the enriched prompt, an SQL query; sending, to a data storage, the SQL query to retrieve data associated with the enriched prompt; and updating the UI to present the retrieved data.
Item [13]: The method according to one or more of items [11]-[12], wherein the category of the enriched prompt may include a generic response category, and wherein the providing the service comprises: generating a response based on the enriched prompt and an NLP model; and updating the UI to present the response in natural language.
Item [14]: The method according to one or more of items [11]-[13], wherein the category of the enriched prompt may include an operational instruction category, and wherein the providing the service comprises: selecting, from among a plurality of applications, an application associated with the enriched prompt; generating, based on the enriched prompt, an instruction executable by the selected application to implement an operation on a network element in the telecommunication network; providing, to the selected application, the generated instruction; receiving, from the selected application, a result of implementation of the operation; updating the UI to present the result of the implementation of the operation.
Item [15]: A system that may include a first device and a second device. The first device may be configured to: receive a prompt associated with a telecommunication network; determine, via a Natural Language Processing (NLP) operation, an intent of the prompt; generate, via a Retrieval-Augmented Generation (RAG) operation, an enriched prompt that includes information associated with the determined intent; determine a category of the enriched prompt; and output the enriched prompt according to the determined category. The second device may be configured to: receive, from the first device, the enriched prompt; and provide a service based on the enriched prompt.
Item [16]: The system according to item [15], further including a third device that may be configured to: present, to a user equipment (UE), a user interface (UI); receive, from the UE and via the UI, the prompt; forward the prompt to the first device; receive, from the second device, a response associated with the prompt; and update the UI to present the response.
Item [17]: The system according to item [16], wherein the category of the enriched prompt may include an operational instruction category, and wherein the second device may be configured to provide the service by: selecting, from among a plurality of fourth devices, a fourth device that manages an application associated with the enriched prompt; generating, based on the enriched prompt, an instruction executable by the application associated with the selected fourth device to implement an operation on a network element in the telecommunication network; providing, to the selected fourth device, the generated instruction; receiving, from the selected fourth device, a result of implementation of the operation; obtaining a response based on the result of the implementation of the operation; and providing the response to the third device.
Item [18]: The system according to one or more of items [16]-[17], wherein the category of the enriched prompt may include a data retrieval category, and wherein the second device may be configured to provide the service by: generating, based on the enriched prompt, an SQL query; sending, to a data storage, the SQL query to retrieve data associated with the enriched prompt; obtaining a response based on the retrieved data; and providing the response to the third device.
Item [19]: The system according to one or more of items [16]-[18], wherein the category of the enriched prompt may include a generic response category, and wherein the second device may be configured to provide the service by: generating a response based on the enriched prompt and an NLP model, wherein the response is presented in natural language; and providing the response to the third device.
Item [20]: The system according to one or more of items [15]-[19], wherein the NLP operation may include: inputting the prompt into an NLP model; obtaining, from the NLP model, an intent classification of the prompt; and determining, based on the intent classification, the intent of the prompt; and wherein the RAG operation may include: accessing a database that stores data associated with the telecommunication network; retrieving, from the database, data associated with the determined intent of the prompt; and integrating the retrieved data with the prompt to obtain the enriched prompt.

It can be understood that numerous modifications and variations of the present disclosure are possible in light of the above teachings. It will be apparent that within the scope of the appended clauses, the present disclosures may be practiced otherwise than as specifically described herein.

1. A device configured to:
receive a prompt associated with a telecommunication network;
determine, via a Natural Language Processing (NLP) operation, an intent of the prompt;
generate, via a Retrieval-Augmented Generation (RAG) operation, an enriched prompt that includes information associated with the determined intent;
determine a category of the enriched prompt, wherein the category is determined based on an analysis of the enriched prompt;
select, from among a plurality of services, a service associated with the determined category; and
provide the selected service based on the enriched prompt.

2. The device according to claim 1, wherein the NLP operation comprises:
inputting the prompt into an NLP model;
obtaining, from the NLP model, an intent classification of the prompt; and
determining, based on the intent classification, the intent of the prompt.

3. The device according to claim 1, wherein the RAG operation comprises:
accessing a database that stores data associated with the telecommunication network;
retrieving, from the database, data associated with the determined intent of the prompt; and
integrating the retrieved data with the prompt to obtain the enriched prompt.

4. The device according to claim 1, wherein the device is further configured to:
present, to a user equipment (UE), a user interface (UI);
receive, from the UE and via the UI, the prompt;
receive, from the selected service, a response associated with the prompt; and
update the UI to present the response.

5. The device according to claim 4,
wherein the category of the enriched prompt comprises a data retrieval category, and
wherein the device is configured to provide the service by:
generating, based on the enriched prompt, an SQL query;
sending, to a data storage, the SQL query to retrieve data associated with the enriched prompt; and
updating the UI to present the retrieved data.

6. The device according to claim 4,
wherein the category of the enriched prompt comprises a generic response category, and
wherein the device is configured to provide the service by:
generating a response based on the enriched prompt and an NLP model; and
updating the UI to present the response in natural language.

7. The device according to claim 4,
wherein the category of the enriched prompt comprises an operational instruction category, and
wherein the device is configured to provide the service by:
selecting, from among a plurality of applications, an application associated with the enriched prompt;
generating, based on the enriched prompt, an instruction executable by the selected application to implement an operation on a network element in the telecommunication network;
providing, to the selected application, the generated instruction;
receiving, from the selected application, a result of implementation of the operation; and
updating the UI to present the result of the implementation of the operation.

8. A method comprising:
receiving a prompt associated with a telecommunication network;
determining, via a Natural Language Processing (NLP) operation, an intent of the prompt;
generating, via a Retrieval-Augmented Generation (RAG) operation, an enriched prompt that includes information associated with the determined intent;
determining a category of the enriched prompt, wherein the category is determined based on an analysis of the enriched prompt;
selecting, from among a plurality of services, a service associated with the determined category; and
providing the selected service based on the enriched prompt.

9. The method according to claim 8, wherein the NLP operation comprises:
inputting the prompt into an NLP model;
obtaining, from the NLP model, an intent classification of the prompt; and
determining, based on the intent classification, the intent of the prompt.

10. The method according to claim 8, wherein the RAG operation comprises:
accessing a database that stores data associated with the telecommunication network;
retrieving, from the database, data associated with the determined intent of the prompt; and
integrating the retrieved data with the prompt to obtain the enriched prompt.

11. The method according to claim 8, further comprising:
presenting, to a user equipment (UE), a user interface UI;
receiving, from the UE and via the UI, the prompt;
receiving, from the selected service, a response associated with the prompt; and
updating the UI to present the response.

12. The method according to claim 11, wherein the category of the enriched prompt comprises
a data retrieval category, and wherein the providing the service comprises:
generating, based on the enriched prompt, an SQL query;
sending, to a data storage, the SQL query to retrieve data associated with the enriched prompt; and
updating the UI to present the retrieved data.

13. The method according to claim 11, wherein the category of the enriched prompt comprises a generic response category, and wherein the providing the service comprises:
generating a response based on the enriched prompt and an NLP model; and
updating the UI to present the response in natural language.

14. The method according to claim 11, wherein the category of the enriched prompt comprises an operational instruction category, and wherein the providing the service comprises:
selecting, from among a plurality of applications, an application associated with the enriched prompt;
generating, based on the enriched prompt, an instruction executable by the selected application to implement an operation on a network element in the telecommunication network;
providing, to the selected application, the generated instruction;
receiving, from the selected application, a result of implementation of the operation; and
updating the UI to present the result of the implementation of the operation.

15. A system comprising:
a first device configured to:
receive a prompt associated with a telecommunication network;
determine, via a Natural Language Processing (NLP) operation, an intent of the prompt;
generate, via a Retrieval-Augmented Generation (RAG) operation, an enriched prompt that includes information associated with the determined intent;
determine a category of the enriched prompt, wherein the category is determined based on an analysis of the enriched prompt;
output the enriched prompt according to the determined category; and
a second device configured to:
receive, from the first device, the enriched prompt; and
provide a service based on the enriched prompt.

16. The system according to claim 15, further comprising a third device configured to:
present, to a user equipment (UE), a user interface (UI);
receive, from the UE and via the UI, the prompt;
forward the prompt to the first device;
receive, from the second device, a response associated with the prompt; and
update the UI to present the response.

17. The system according to claim 16,
wherein the category of the enriched prompt comprises an operational instruction category, and
wherein the second device is configured to provide the service by:
selecting, from among a plurality of fourth devices, a fourth device that manages an application associated with the enriched prompt;
generating, based on the enriched prompt, an instruction executable by the application associated with the selected fourth device to implement an operation on a network element in the telecommunication network; providing, to the selected fourth device, the generated instruction;
receiving, from the selected fourth device, a result of implementation of the operation;
obtaining a response based on the result of the implementation of the operation; and
providing the response to the third device.

18. The device according to claim 16,
wherein the category of the enriched prompt comprises a data retrieval category, and
wherein the second device is configured to provide the service by:
generating, based on the enriched prompt, an SQL query;
sending, to a data storage, the SQL query to retrieve data associated with the enriched prompt;
obtaining a response based on the retrieved data; and
providing the response to the third device.

19. The system according to claim 16
wherein the category of the enriched prompt comprises a generic response category, and
wherein the second device is configured to provide the service by:
generating a response based on the enriched prompt and an NLP model, wherein
the response is presented in natural language; and
providing the response to the third device.

20. The system according to claim 15,
wherein the NLP operation comprises:
inputting the prompt into an NLP model;
obtaining, from the NLP model, an intent classification of the prompt;
determining, based on the intent classification, the intent of the prompt; and
wherein the RAG operation comprises:
accessing a database that stores data associated with the telecommunication network;
retrieving, from the database, data associated with the determined intent of the prompt; and
integrating the retrieved data with the prompt to obtain the enriched prompt.
